(19) United States
(12) Patent Application Publication
(10) Pub. No.: US 2025/0240798 A1
(43) Pub. Date: Jul. 24, 2025

(54) CONTROL SIGNALING FOR TRANSPORT BLOCKS IN SLOT AGGREGATION

(71) Applicant: QUALCOMM Incorporated, San Diego, CA (US)

(72) Inventors: Guangyi LIU, Shanghai (CN); Gabi SARKIS, San Diego, CA (US); Wanshi CHEN, San Diego, CA (US)

(21) Appl. No.: 18/879,645

(22) PCT Filed: Aug. 11, 2022
(86) PCT No.: PCT/CN2022/111757

§ 371 Date: Dec. 27, 2024

(51) Int. Cl. H04W 72/25; H04L 1/00; H04W 28/26; H04W 72/0446; H04W 72/12

(52) U.S. Cl. CPC H04W 72/25; H04L 1/0005; H04W 28/26; H04W 72/0446; H04W 72/12

(57) ABSTRACT

Methods, systems, and devices for wireless communications are described. A transmitted sidelink packet may span multiple slots and may include multiple transport blocks. A transmitting user equipment (UE), may indicate to the receiving UE via control resources (e.g., a sidelink control information (SCI) message) within the first slot of the multiple slots scheduling parameters common to the multiple transport blocks. The transmitting UE may indicate, to the receiving UE, additional scheduling parameters for the multiple transport blocks via at least one additional SCI message. The transmitting UE may indicate, to the receiving UE, a reservation of multiple slots for a slot aggregated packet via an SCI message. The transmitting UE may indicate, to the receiving UE, reservation information for the transport blocks of the slot aggregated packet (e.g., a time domain resource allocation and/or a frequency domain resource allocation).

### CROSS REFERENCE

The present Application is a 371 national stage filing of International PCT Application No. PCT/CN2022/111757 by LIU et al. entitled “CONTROL SIGNALING FOR TRANSPORT BLOCKS IN SLOT AGGREGATION,” filed Aug. 11, 2022, which is assigned to the assignee hereof, and which is expressly incorporated by reference in its entirety herein.

### INTRODUCTION

The following relates to wireless communications, and more specifically to management of transport blocks in slot aggregation.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

A method for wireless communications at a first user equipment (UE) is described. The method may include transmitting, to a second UE, a first-stage sidelink control information (SCI) message associated with a set of multiple transport blocks, the first-stage SCI message indicating a common set of scheduling parameters common to the set of multiple transport blocks. The method may include transmitting, to the second UE, at least one second-stage SCI message that indicates additional scheduling parameters for the set of multiple transport blocks. The method may include transmitting, to the second UE, the set of multiple transport blocks via a set of multiple aggregated slots in accordance with the common set of scheduling parameters and the additional scheduling parameters.

An apparatus for wireless communications at a first UE is described. The apparatus may include a processor, and memory coupled with the processor. The processor may be configured to transmit, to a second UE, a first-stage SCI message associated with a set of multiple transport blocks, the first-stage SCI message indicating a common set of scheduling parameters common to the set of multiple transport blocks. The processor may be configured to transmit, to the second UE, at least one second-stage SCI message that indicates additional scheduling parameters for the set of multiple transport blocks. The processor may be configured to transmit, to the second UE, the set of multiple transport blocks via a set of multiple aggregated slots in accordance with the common set of scheduling parameters and the additional scheduling parameters.

Another apparatus for wireless communications at a first UE is described. The apparatus may include means for transmitting, to a second UE, a first-stage SCI message associated with a set of multiple transport blocks, the first-stage SCI message indicating a common set of scheduling parameters common to the set of multiple transport blocks. The apparatus may include means for transmitting, to the second UE, at least one second-stage SCI message that indicates additional scheduling parameters for the set of multiple transport blocks. The apparatus may include means for transmitting, to the second UE, the set of multiple transport blocks via a set of multiple aggregated slots in accordance with the common set of scheduling parameters and the additional scheduling parameters.

A non-transitory computer-readable medium storing code for wireless communications at a first UE is described. The code may include instructions executable by a processor to transmit, to a second UE, a first-stage SCI message associated with a set of multiple transport blocks, the first-stage SCI message indicating a common set of scheduling parameters common to the set of multiple transport blocks. The code may further include instructions executable by the processor to transmit, to the second UE, at least one second-stage SCI message that indicates additional scheduling parameters for the set of multiple transport blocks. The code may further include instructions executable by the processor to transmit, to the second UE, the set of multiple transport blocks via a set of multiple aggregated slots in accordance with the common set of scheduling parameters and the additional scheduling parameters.

In some examples of the method, apparatuses, and non-transitory computer-readable medium described herein, transmitting the at least one second-stage SCI message may include operations, features, means, or instructions for transmitting, via a temporally first slot of the set of multiple aggregated slots, a set of multiple second-stage SCI messages for the set of multiple transport blocks.

In some examples of the method, apparatuses, and non-transitory computer-readable medium described herein, transmitting the first-stage SCI message may include operations, features, means, or instructions for transmitting an indication of a common format for the set of multiple second-stage SCI messages.

In some examples of the method, apparatuses, and non-transitory computer-readable medium described herein, transmitting the at least one second-stage SCI message may include operations, features, means, or instructions for transmitting a single second-stage SCI message via a temporally first slot of the set of multiple aggregated slots, the single second-stage SCI message including a set of multiple sets of additional scheduling parameters for the set of multiple transport blocks.

In some examples of the method, apparatuses, and non-transitory computer-readable medium described herein, transmitting the at least one second-stage SCI message may include operations, features, means, or instructions for transmitting, via a first transport block of the set of multiple transport blocks, a first second-stage SCI message for the first transport block. In some examples of the method, apparatuses, and non-transitory computer-readable medium described herein, transmitting the at least one second-stage SCI message may further include operations, features, means, or instructions for transmitting, via a second transport block of the set of multiple transport blocks, a second second-stage SCI message for the second transport block.

In some examples of the method, apparatuses, and non-transitory computer-readable medium described herein, transmitting the first-stage SCI message may include operations, features, means, or instructions for transmitting an indication of a common format for the first second-stage SCI message and the second second-stage SCI message.

In some examples of the method, apparatuses, and non-transitory computer-readable medium described herein, transmitting the first-stage SCI message may include operations, features, means, or instructions for transmitting an indication of a first format for the first second-stage SCI message, where the first second-stage SCI message includes an indication of a second format for the second second-stage SCI message.

In some examples of the method, apparatuses, and non-transitory computer-readable medium described herein, transmitting the first-stage SCI message may include operations, features, means, or instructions for transmitting an indication of a first format for the first second-stage SCI message, where the first second-stage SCI message includes an indication of a second format for the second second-stage SCI message, and where the second second-stage SCI message includes an indication of a third format for a third second-stage SCI message for a third transport block of the set of multiple transport blocks.

In some examples of the method, apparatuses, and non-transitory computer-readable medium described herein, transmitting the at least one second-stage SCI message may include operations, features, means, or instructions for transmitting, via a temporally first slot of the set of multiple aggregated slots, a first second-stage SCI message for a temporally first transport block of the set of multiple transport blocks, the first second-stage SCI message including at least one scheduling parameter common to the set of multiple transport blocks. In some examples of the method, apparatuses, and non-transitory computer-readable medium described herein, transmitting the at least one second-stage SCI message may further include operations, features, means, or instructions for transmitting, via a second transport block of the set of multiple transport blocks, a second second-stage SCI message including at least one scheduling parameter for the second transport block.

In some examples of the method, apparatuses, and non-transitory computer-readable medium described herein, transmitting the first-stage SCI message may include operations, features, means, or instructions for transmitting the first-stage SCI message via a temporally first slot of the set of multiple aggregated slots.

In some examples of the method, apparatuses, and non-transitory computer-readable medium described herein, the additional scheduling parameters include one or more destination identifiers for the set of multiple transport blocks, one or more modulation and coding schemes for the set of multiple transport blocks, one or more time domain resource allocations for the set of multiple transport blocks, or a combination thereof.

A method for wireless communications at a second UE is described. The method may include receiving, from a first UE, a first-stage SCI message associated with a set of multiple transport blocks, the first-stage SCI message indicating a common set of scheduling parameters common to the set of multiple transport blocks. The method may include receiving, from the first UE, at least one second-stage SCI message that indicates additional scheduling parameters the set of multiple transport blocks. The method may include receiving, from the first UE, the set of multiple transport blocks via a set of multiple aggregated slots in accordance with the common set of scheduling parameters and the additional scheduling parameters.

An apparatus for wireless communications at a second UE is described. The apparatus may include a processor, and memory coupled with the processor. The processor may be configured to receive, from a first UE, a first-stage SCI message associated with a set of multiple transport blocks, the first-stage SCI message indicating a common set of scheduling parameters common to the set of multiple transport blocks. The processor may be configured to receive, from the first UE, at least one second-stage SCI message that indicates additional scheduling parameters the set of multiple transport blocks. The processor may be configured to receive, from the first UE, the set of multiple transport blocks via a set of multiple aggregated slots in accordance with the common set of scheduling parameters and the additional scheduling parameters.

Another apparatus for wireless communications at a second UE is described. The apparatus may include means for receiving, from a first UE, a first-stage SCI message associated with a set of multiple transport blocks, the first-stage SCI message indicating a common set of scheduling parameters common to the set of multiple transport blocks. The apparatus may include means for receiving, from the first UE, at least one second-stage SCI message that indicates additional scheduling parameters the set of multiple transport blocks. The apparatus may include means for receiving, from the first UE, the set of multiple transport blocks via a set of multiple aggregated slots in accordance with the common set of scheduling parameters and the additional scheduling parameters.

A non-transitory computer-readable medium storing code for wireless communications at a second UE is described. The code may include instructions executable by a processor to receive, from a first UE, a first-stage SCI message associated with a set of multiple transport blocks, the first-stage SCI message indicating a common set of scheduling parameters common to the set of multiple transport blocks. The code may further include instructions executable by the processor to receive, from the first UE, at least one second-stage SCI message that indicates additional scheduling parameters the set of multiple transport blocks. The code may further include instructions executable by the processor to receive, from the first UE, the set of multiple transport blocks via a set of multiple aggregated slots in accordance with the common set of scheduling parameters and the additional scheduling parameters.

In some examples of the method, apparatuses, and non-transitory computer-readable medium described herein, receiving the at least one second-stage SCI message may include operations, features, means, or instructions for receiving, via a temporally first slot of the set of multiple aggregated slots, a set of multiple second-stage SCI messages for the set of multiple transport blocks.

In some examples of the method, apparatuses, and non-transitory computer-readable medium described herein, receiving the first-stage SCI message may include operations, features, means, or instructions for receiving an indication of a common format for the set of multiple second-stage SCI messages.

In some examples of the method, apparatuses, and non-transitory computer-readable medium described herein, receiving the at least one second-stage SCI message may include operations, features, means, or instructions for receiving a single second-stage SCI message via a temporally first slot of the set of multiple aggregated slots, the single second-stage SCI message including a set of multiple sets of additional scheduling parameters for the set of multiple transport blocks.

In some examples of the method, apparatuses, and non-transitory computer-readable medium described herein, receiving the at least one second-stage SCI message may include operations, features, means, or instructions for receiving, via a first transport block of the set of multiple transport blocks, a first second-stage SCI message for the first transport block. In some examples of the method, apparatuses, and non-transitory computer-readable medium described herein, receiving the at least one second-stage SCI message may further include operations, features, means, or instructions for receiving, via a second transport block of the set of multiple transport blocks, a second second-stage SCI message for the second transport block.

In some examples of the method, apparatuses, and non-transitory computer-readable medium described herein, receiving the first-stage SCI message may include operations, features, means, or instructions for receiving an indication of a common format for the first second-stage SCI message and the second second-stage SCI message.

In some examples of the method, apparatuses, and non-transitory computer-readable medium described herein, receiving the first-stage SCI message may include operations, features, means, or instructions for receiving an indication of a first format for the first second-stage SCI message, where the first second-stage SCI message includes an indication of a second format for the second second-stage SCI message.

In some examples of the method, apparatuses, and non-transitory computer-readable medium described herein, receiving the first-stage SCI message may include operations, features, means, or instructions for receiving an indication of a first format for the first second-stage SCI message, where the first second-stage SCI message includes an indication of a second format for the second second-stage SCI message, and where the second second-stage SCI message includes an indication of a third format for a third second-stage SCI message for a third transport block of the set of multiple transport blocks.

In some examples of the method, apparatuses, and non-transitory computer-readable medium described herein, receiving the at least one second-stage SCI message may include operations, features, means, or instructions for receiving, via a temporally first slot of the set of multiple aggregated slots, a first second-stage SCI message for a temporally first transport block of the set of multiple transport blocks, the first second-stage SCI message including at least one scheduling parameter common to the set of multiple transport blocks. In some examples of the method, apparatuses, and non-transitory computer-readable medium described herein, receiving the at least one second-stage SCI message may further include operations, features, means, or instructions for receiving, via a second transport block of the set of multiple transport blocks, a second second-stage SCI message including at least one scheduling parameter for the second transport block.

In some examples of the method, apparatuses, and non-transitory computer-readable medium described herein, receiving the first-stage SCI message may include operations, features, means, or instructions for receiving the first-stage SCI message via a temporally first slot of the set of multiple aggregated slots.

In some examples of the method, apparatuses, and non-transitory computer-readable medium described herein, the additional scheduling parameters include one or more destination identifiers for the set of multiple transport blocks, one or more modulation and coding schemes for the set of multiple transport blocks, one or more time domain resource allocations for the set of multiple transport blocks, or a combination thereof.

A method for wireless communications at a first UE is described. The method may include transmitting, to a second UE, a first SCI message indicating a reservation of a set of multiple slots and indicating reservation information for a slot aggregated packet that is aggregated across one or more slots of the set of multiple slots, the slot aggregated packet including one or more transport blocks. The method may include transmitting, to the second UE, the slot aggregated packet via the set of multiple slots based on the reservation information.

An apparatus for wireless communications at a first UE is described. The apparatus may include a processor, and memory coupled with the processor. The processor may be configured to transmit, to a second UE, a first SCI message indicating a reservation of a set of multiple slots and indicating reservation information for a slot aggregated packet that is aggregated across one or more slots of the set of multiple slots, the slot aggregated packet including one or more transport blocks. The processor may be configured to transmit, to the second UE, the slot aggregated packet via the set of multiple slots based on the reservation information.

Another apparatus for wireless communications at a first UE is described. The apparatus may include means for transmitting, to a second UE, a first SCI message indicating a reservation of a set of multiple slots and indicating reservation information for a slot aggregated packet that is aggregated across one or more slots of the set of multiple slots, the slot aggregated packet including one or more transport blocks. The apparatus may include means for transmitting, to the second UE, the slot aggregated packet via the set of multiple slots based on the reservation information.

A non-transitory computer-readable medium storing code for wireless communications at a first UE is described. The code may include instructions executable by a processor to transmit, to a second UE, a first SCI message indicating a reservation of a set of multiple slots and indicating reservation information for a slot aggregated packet that is aggregated across one or more slots of the set of multiple slots, the slot aggregated packet including one or more transport blocks. The code may further include instructions executable by the processor to transmit, to the second UE, the slot aggregated packet via the set of multiple slots based on the reservation information.

In some examples of the method, apparatuses, and non-transitory computer-readable medium described herein, transmitting the first SCI message indicating the reservation of the set of multiple slots may include operations, features, means, or instructions for transmitting an indication of a beginning slot and a quantity of slots.

Some examples of the method, apparatuses, and non-transitory computer-readable medium described herein may further include operations, features, means, or instructions for receiving, from the second UE, feedback indicating unsuccessful reception of a transport block of the slot aggregated packet. Some examples of the method, apparatuses, and non-transitory computer-readable medium described herein may further include operations, features, means, or instructions for transmitting, to the second UE and in response to the feedback, a second SCI message indicating a second reservation of a second set of multiple slots and second reservation information for a retransmission of the slot aggregated packet, the second reservation corresponding to the reservation and the second reservation information corresponding to the reservation information.

Some examples of the method, apparatuses, and non-transitory computer-readable medium described herein may further include operations, features, means, or instructions for receiving, from the second UE, feedback indicating unsuccessful reception of a transport block of the slot aggregated packet. Some examples of the method, apparatuses, and non-transitory computer-readable medium described herein may further include operations, features, means, or instructions for transmitting, to the second UE and in response to the feedback, a second SCI message indicating a second reservation of a slot for a retransmission of the transport block. Some examples of the method, apparatuses, and non-transitory computer-readable medium described herein may further include operations, features, means, or instructions for transmitting, to the second UE via the slot, second reservation information for the retransmission of the transport block.

In some examples of the method, apparatuses, and non-transitory computer-readable medium described herein, the reservation information includes a respective time domain resource allocation and frequency domain resource allocation for the one or more transport blocks.

In some examples of the method, apparatuses, and non-transitory computer-readable medium described herein, transmitting the first SCI message indicating the reservation of the set of multiple slots may include operations, features, means, or instructions for transmitting an indication of a beginning slot, and where respective second SCI messages transmitted via respective transport blocks of the one or more transport blocks indicate respective reservation information for the respective transport blocks.

Some examples of the method, apparatuses, and non-transitory computer-readable medium described herein may further include operations, features, means, or instructions for selecting the set of multiple slots based on the set of multiple slots satisfying one or more conditions.

A method for wireless communications at a second UE is described. The method may include receiving, from a first UE, a first SCI message indicating a reservation of a set of multiple slots and indicating reservation information for a slot aggregated packet that is aggregated across one or more slots of the set of multiple slots, the slot aggregated packet including one or more transport blocks. The method may include receiving, from the first UE, the slot aggregated packet via the set of multiple slots based on the reservation information.

An apparatus for wireless communications at a second UE is described. The apparatus may include a processor, and memory coupled with the processor. The processor may be configured to receive, from a first UE, a first SCI message indicating a reservation of a set of multiple slots and indicating reservation information for a slot aggregated packet that is aggregated across one or more slots of the set of multiple slots, the slot aggregated packet including one or more transport blocks. The processor may be configured to receive, from the first UE, the slot aggregated packet via the set of multiple slots based on the reservation information.

Another apparatus for wireless communications at a second UE is described. The apparatus may include means for receiving, from a first UE, a first SCI message indicating a reservation of a set of multiple slots and indicating reservation information for a slot aggregated packet that is aggregated across one or more slots of the set of multiple slots, the slot aggregated packet including one or more transport blocks. The apparatus may include means for receiving, from the first UE, the slot aggregated packet via the set of multiple slots based on the reservation information.

A non-transitory computer-readable medium storing code for wireless communications at a second UE is described. The code may include instructions executable by a processor to receive, from a first UE, a first SCI message indicating a reservation of a set of multiple slots and indicating reservation information for a slot aggregated packet that is aggregated across one or more slots of the set of multiple slots, the slot aggregated packet including one or more transport blocks. The code may further include instructions executable by the processor to receive, from the first UE, the slot aggregated packet via the set of multiple slots based on the reservation information.

In some examples of the method, apparatuses, and non-transitory computer-readable medium described herein, receiving the first SCI message indicating the reservation of the set of multiple slots may include operations, features, means, or instructions for receiving an indication of a beginning slot and a quantity of slots.

Some examples of the method, apparatuses, and non-transitory computer-readable medium described herein may further include operations, features, means, or instructions for transmitting, to the first UE, feedback indicating unsuccessful reception of a transport block of the slot aggregated packet. Some examples of the method, apparatuses, and non-transitory computer-readable medium described herein may further include operations, features, means, or instructions for receiving, from the first UE and in response to the feedback, a second SCI message indicating a second reservation of a second set of multiple slots and second reservation information for a retransmission of the slot aggregated packet, the second reservation corresponding to the reservation and the second reservation information corresponding to the reservation information.

Some examples of the method, apparatuses, and non-transitory computer-readable medium described herein may further include operations, features, means, or instructions for transmitting, to the first UE, feedback indicating unsuccessful reception of a transport block of the slot aggregated packet. Some examples of the method, apparatuses, and non-transitory computer-readable medium described herein may further include operations, features, means, or instructions for receiving, from the first UE and in response to the feedback, a second SCI message indicating a second reservation of a slot for a retransmission of the transport block. Some examples of the method, apparatuses, and non-transitory computer-readable medium described herein may further include operations, features, means, or instructions for receiving, from the first UE via the slot, second reservation information for the retransmission of the transport block.

In some examples of the method, apparatuses, and non-transitory computer-readable medium described herein, the reservation information includes a respective time domain resource allocation and frequency domain resource allocation for the one or more transport blocks.

In some examples of the method, apparatuses, and non-transitory computer-readable medium described herein, receiving the first SCI message indicating the reservation of the set of multiple slots may include operations, features, means, or instructions for receiving an indication of a beginning slot, and where respective second SCI messages transmitted via respective transport blocks of the one or more transport blocks indicate respective reservation information for the respective transport blocks.

### BRIEF DESCRIPTION OF THE DRAWINGS

FIG. 1 illustrates an example of a wireless communications system that supports control signaling for transport blocks in slot aggregation in accordance with one or more aspects of the present disclosure.

FIG. 2 illustrates an example of a wireless communications system that supports control signaling for transport blocks in slot aggregation in accordance with one or more aspects of the present disclosure.

FIG. 3 illustrates an example of a slot format that supports control signaling for transport blocks in slot aggregation in accordance with one or more aspects of the present disclosure.

FIG. 4 illustrates an example of an aggregated slot format that supports control signaling for transport blocks in slot aggregation in accordance with one or more aspects of the present disclosure.

FIG. 5 illustrates an example of an aggregated slot format that supports control signaling for transport blocks in slot aggregation in accordance with one or more aspects of the present disclosure.

FIG. 6 illustrates an example of an aggregated slot format that supports control signaling for transport blocks in slot aggregation in accordance with one or more aspects of the present disclosure.

FIG. 7 illustrates an example of a process flow that supports control signaling for transport blocks in slot aggregation in accordance with one or more aspects of the present disclosure.

FIG. 8 illustrates an example of a process flow that supports control signaling for transport blocks in slot aggregation in accordance with one or more aspects of the present disclosure.

FIGS. 9 and 10 show block diagrams of devices that support control signaling for transport blocks in slot aggregation in accordance with one or more aspects of the present disclosure.

FIG. 11 shows a block diagram of a communications manager that supports control signaling for transport blocks in slot aggregation in accordance with one or more aspects of the present disclosure.

FIG. 12 shows a diagram of a system including a device that supports control signaling for transport blocks in slot aggregation in accordance with one or more aspects of the present disclosure.

FIGS. 13 through 16 show flowcharts illustrating methods that support control signaling for transport blocks in slot aggregation in accordance with one or more aspects of the present disclosure.

### DETAILED DESCRIPTION

Some wireless communications systems support sidelink communications between UEs. In some examples of such wireless communications systems, UEs may coordinate scheduling of sidelink transmissions among each other and some wireless communications systems may implement slot aggregation or mini slot aggregation in sidelink communications. For example, the quantity or number of symbols in a mini slot may be half of the amount in a slot. For instance, in one example, a slot may include 14 orthogonal frequency division multiplexing (OFDM) symbols and a mini slot may include 7 OFDM symbols. A slot aggregated packet refers to a packet that is transmitted via multiple contiguous slots (e.g., the packet spans multiple contiguous slots), and includes some control resources common to the packet in the temporally first slot of the multiple slots. Accordingly, slot aggregation refers to transmission of a packet over multiple contiguous slots and transmission of some control resources common to the multiple slots in the temporally first slot of the multiple contiguous slots. Multiple contiguous slots may be referred to as aggregated if a packet is transmitted over the multiple contiguous slots and some control resources common to the packet are indicated in the temporally first slot of the multiple slots. For example, control resources include demodulation reference signal (DMRS) resources and physical sidelink control channel (PSCCH) resources. In some examples, resources may include automatic gain control (AGC) resources. Slot aggregated packets may increase efficiency by reducing control overhead as compared to packets transmitted in individual slots because in a slot aggregated packet, at least some of the control resources common to the packet are transmitted in only the temporally first slot instead of being transmitted in each of the individual slots. A slot aggregated packet may include multiple transport blocks. A transport block refers to a payload which is passed between the medium access control (MAC) layer and the physical layer (e.g., for transmission via a data channel such as physical sidelink shared channel (PSSCH)).

In a slot aggregated packet, each transport block may have different scheduling parameters, such as modulation and coding scheme(s) (MCS) s, time domain resource allocations (TDRA) s, frequency domain resource allocations (FDRA) s, priorities, or destination identifiers. An MCS may define a quantity or number of information bits that may be carried per resource element (RE). A resource element may refer to resources of one symbol period (e.g., a duration of one modulation symbol) and one subcarrier. A transmitting UE may indicate scheduling parameters for a packet transmitted over a single slot via control resources such as one or more sidelink control information (SCI) messages that may be transmitted within the single slot. A first-stage SCI message refers to an SCI message conveyed via a PSCCH, and may be referred to as an SCI-1. A second stage SCI refers to an SCI message conveyed via PSSCH, and may be referred to as an SCI-2. As the transport blocks in a slot aggregated packet may include different scheduling parameters (e.g., different MCSs, priorities, TDRAs, FDRAs, or destination identifiers) due to the information conveyed in the transport blocks and resources available, SCI messages that convey only a common set of scheduling parameters may be unable to account for the different scheduling parameters between the different transport blocks as the common set may be common to all transport blocks. Further, a scheduling of a slot aggregated packet may involve reserving resources for the multiple slots instead of a single slot.

Aspects of the present disclosure relate to techniques for scheduling slot aggregated packets. A transmitting UE (e.g., the UE that will transmit a slot aggregated packet) may transmit an SCI (e.g., a first-stage SCI) to a receiving UE (e.g., the intended recipient UE of the slot aggregated packet) that indicates a common set of scheduling parameters that are common to the multiple transport blocks within a slot aggregated packet. The transmitting UE may transmit at least one additional SCI message (e.g., second stage SCI messages) that indicates additional scheduling parameters for the multiple transport blocks of the slot aggregated packet. Accordingly, the transmitting UE may indicate the scheduling parameters that are common to the multiple transport blocks of the slot aggregated packet via a first SCI message and may indicate the additional scheduling parameters that are specific to each different transport block of the multiple transport blocks via one or more second SCI messages. For example, each transport block may include an SCI-2 message indicating the additional scheduling parameters for that transport block. As another example, the first slot of the slot aggregated packet may include a single SCI-2 message that indicates the additional scheduling parameters for the multiple transport blocks of the slot aggregated packet. For example, the single SCI-2 may include multiple different sets of additional scheduling parameters corresponding to the multiple different transport blocks of the slot aggregated packet. As another example, the first slot of the slot aggregated packet may include multiple SCI-2 messages corresponding to the multiple different transport blocks of the slot aggregated packet, and the multiple SCI-2 messages may include the additional scheduling parameters for the corresponding multiple different transport blocks of the slot aggregated packet.

The transmitting UE may indicate to the receiving UE, via an SCI message(s), a reservation of multiple slots for a slot aggregated packet. The transmitting UE may also indicate, to the receiving UE, via the SCI message(s) reservation information for the slot aggregated packet. Reservation information may include, for example, TDRA, FDRA, or priority, or a combination thereof, for the multiple transport blocks of the slot aggregated packet. In some cases, the reservation may indicate a beginning slot (e.g., from a set of 64 possible candidate slots in a time window) and a quantity of slots for the slot aggregated packet. In some cases, the transmitting UE may reserve, via a first SCI message, a first slot. The additional SCI messages within the additional transport blocks of the slot aggregated packet may reserve additional slots for the slot aggregated packet.

In the event of an unsuccessful transmission, the receiving UE may transmit feedback indicating one or more transport blocks were not successfully received. In some cases, the transmitting UE may reserve the same set of aggregated slots to retransmit an entire slot aggregated packet. In some cases, the transmitting UE may reserve one or more slots to retransmit the failed transport block.

Accordingly, the transmitting UE may indicate both scheduling parameters that are common to the multiple transport blocks of the slot aggregated packet via a first SCI message and may indicate the additional scheduling parameters that are specific to each different transport block of the multiple transport blocks via one or more second SCI messages. Further, the transmitting UE may indicate a reservation of multiple slots for a slot aggregated packet. As described herein, use of a slot aggregated packet and the indication of scheduling parameters may reduce control overhead.

Aspects of the disclosure are initially described in the context of wireless communications systems. Aspects of the disclosure are further illustrated by and described with reference to slot formats, aggregated slot formats, and process flows. Aspects of the disclosure are further illustrated by and described with reference to apparatus diagrams, system diagrams, and flowcharts that relate to control signaling for transport blocks in slot aggregation.

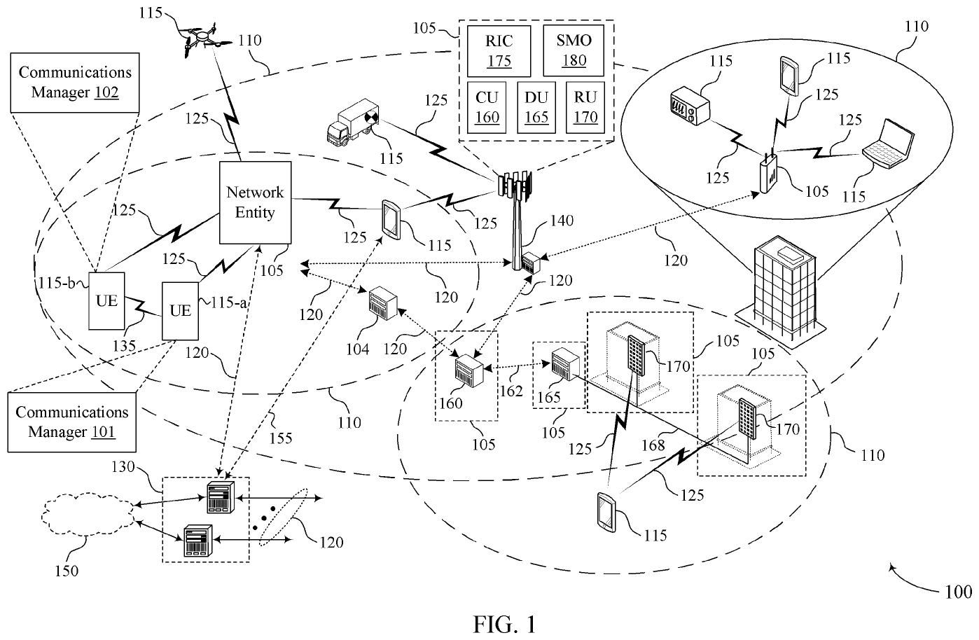

FIG. 1 illustrates an example of a wireless communications system 100 that supports control signaling for transport blocks in slot aggregation in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node. Consistent with this disclosure, once a specific example is broadened in accordance with this disclosure (e.g., a UE 115 is configured to receive information from a network entity 105 also discloses that a first network node is configured to receive information from a second network node), the broader example of the narrower example may be interpreted in the reverse, but in a broad open-ended way. In the example above where a UE 115 being configured to receive information from a network entity 105 also discloses that a first network node being configured to receive information from a second network node, the first network node may refer to a first UE 115, a first network entity 105, a first apparatus, a first device, a first computing system, a first one or more components, a first processing entity, or the like configured to receive the information; and the second network node may refer to a second UE 115, a second network entity 105, a second apparatus, a second device, a second computing system, a second one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, MAC layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support control signaling for transport blocks in slot aggregation as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as OFDM or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). The region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

The wireless communications system 100 may implement slot aggregation and/or mini slot aggregation. In a slot aggregated packet, each transport block may have different scheduling parameters, such as MCSs, TDRAs, FDRAs, priority, or destination identifiers. In some examples, a first UE 115-a may include a communications manager 101 to support various aspects of control signaling for transport blocks in slot aggregation. In some examples, a second UE 115-b may include a communications manager 102 to support various aspects of control signaling for transport blocks in slot aggregation.

In some examples, the first UE 115-a may transmit, to the second UE 115-b via the communications manager 101, and the second UE 115-b may receive, via the communications manager 102, a first-stage SCI message associated with a set of multiple transport blocks, the first-stage SCI message indicating a common set of scheduling parameters common to the set of multiple transport blocks. The first UE 115-a may transmit, to the second UE 115-b via the communications manager 101, and the second UE 115-b may receive, via the communications manager 102, at least one second-stage SCI message that indicates additional scheduling parameters for the set of multiple transport blocks. The first UE 115-a may transmit, to the second UE 115-b via the communications manager 101, and the second UE 115-b may receive, via the communications manager 102, the set of multiple transport blocks via a set of multiple aggregated slots or mini slots (e.g., a slot aggregated packet) in accordance with the common set of scheduling parameters and the additional scheduling parameters. Accordingly, first UE 115-a (the transmitting UE) may indicate the scheduling parameters that are common to the multiple transport blocks of the slot aggregated packet and may indicate the additional scheduling parameters that are specific to each different transport block of the multiple transport blocks.

In some examples, the first UE 115-a may transmit, to the second UE 115-b via the communications manager 101, and the second UE 115-b may receive, via the communications manager 102, a first SCI message indicating a reservation of a set of multiple slots and indicating reservation information for a slot aggregated packet that is aggregated across one or more slots of the set of multiple slots, the slot aggregated packet including one or more transport blocks. The first UE 115-a may transmit, to the second UE 115-b via the communications manager 101, and the second UE 115-b may receive, via the communications manager 102, the slot aggregated packet via the set of multiple slots based on the reservation information.

In the event of an unsuccessful transmission, the second UE 115-b may transmit, via the communications manager 102, and the first UE 115-a may receive, via the communications manager 101, feedback indicating one or more transport blocks was not successfully received. In some cases, the first UE 115-a may indicate a reservation for the same set of aggregated slots to retransmit the entire slot aggregated packet. In some cases, the first UE 115-a may reserve one or more slots to retransmit the failed transport block.

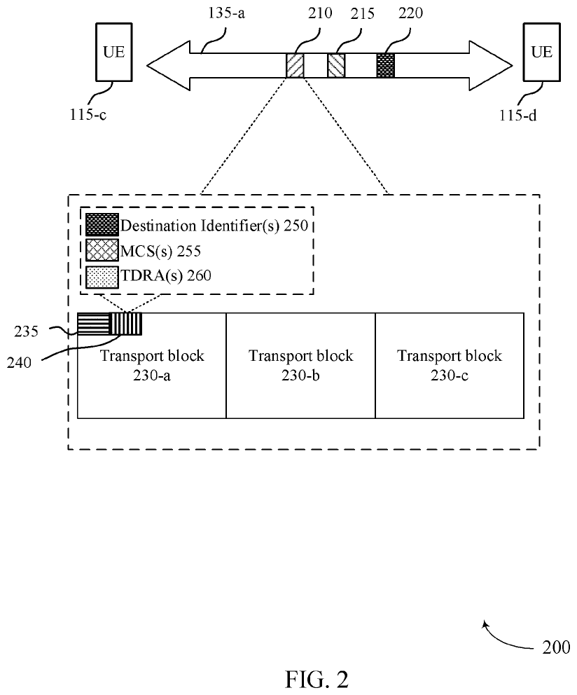

FIG. 2 illustrates an example of a wireless communications system 200 that supports control signaling for transport blocks in slot aggregation in accordance with one or more aspects of the present disclosure. The wireless communications system 200 may include a first UE 115-c and a second UE 115-d, which may be examples of a UE 115 as described herein.

The first UE 115-c may communicate with the second UE 115-d using a sidelink communication link 135-a. The sidelink communication link 135-a may include bi-directional links that enable the first UE 115-c and the second UE 115-d to transmit and receive sidelink signals. In some examples (e.g., in Mode 1), the network (e.g., a serving network entity 105) may configure resources for the sidelink communication link 135-a. In some examples, the first UE 115-c and the second UE 115-d may communicate over the sidelink communication link 135-a using directional communications techniques (e.g., beamforming techniques). In some examples (e.g., in Mode 2), the first UE 115-c and the second UE 115-d may determine and configure the resources for the sidelink communication link 135-a autonomously (e.g., without involvement from a serving network entity 105).

The wireless communications system 200 may implement slot aggregation in sidelink communications. The first UE 115-c may transmit a slot aggregated packet 210 transmitted over a set of aggregated slots (e.g., mini slots). For example, the slot aggregated packet may include a first transport block 230-a, a second transport block 230-b, and a third transport block 230-c.

In some examples, the first UE 115-c may transmit, to the second UE 115-d a first-stage SCI message 235 associated with a set of multiple transport blocks, the first-stage SCI message 235 indicating a common set of scheduling parameters common to the set of multiple transport blocks (e.g., the first transport block 230-a, the second transport block 230-b, and the third transport block 230-c). The first UE 115-c may transmit, to the second UE 115-d, at least one second-stage SCI message 240 that indicates additional scheduling parameters for the set of multiple transport blocks (e.g., the first transport block 230-a, the second transport block 230-b, and the third transport block 230-c). For example, the second-stage SCI 240 may indicate destination identifiers 250 for the transport blocks (e.g., the first transport block 230-a, the second transport block 230-b, and the third transport block 230-c). As another example, the second-stage SCI 240 may indicate MCSs 255 for the transport blocks (e.g., the first transport block 230-a, the second transport block 230-b, and the third transport block 230-c). As another example, the second-stage SCI 240 may indicate TDRAs 260 for the transport blocks (e.g., the first transport block 230-a, the second transport block 230-b, and the third transport block 230-c). The first UE 115-c may transmit, to the second UE 115-d, the set of multiple transport blocks via a set of multiple aggregated slots (e.g., via the slot aggregated packet 210) in accordance with the common set of scheduling parameters and the additional scheduling parameters. The first-stage SCI and the at least one second-stage SCI may be transmitted within the slot aggregated packet 210. Accordingly, the first UE 115-c may indicate the scheduling parameters that are common to the multiple transport blocks of the slot aggregated packet 210 and may indicate the additional scheduling parameters that are specific to each different transport block of the multiple transport blocks.

In some examples, the first UE 115-c may transmit, to the second UE 115-d, a first SCI message indicating a reservation of a set of multiple slots and indicating reservation information for the slot aggregated packet 210, the slot aggregated packet including one or more transport blocks. The first UE 115-c may transmit, to the second UE 115-d, the slot aggregated packet 210 via the set of multiple slots based on the reservation information. The SCI message may be transmitted within the slot aggregated packet 210.

The second UE 115-d may transmit feedback 215 (e.g., an acknowledgment (ACK) or a negative acknowledgment (NACK)) for each transport block in the slot aggregated packet 210. In the case that the second UE 115-d does not successfully receive a transport block of the slot aggregated packet, the second UE 115-d may transmit a NACK for the transport block to the first UE 115-c. In response to the NACK, the first UE 115-c may transmit a retransmission 220 of the failed transport block or of the entire slot aggregated packet 210 to the second UE 115-d. For example, the first UE 115-c may indicate, via one or more SCI messages within the retransmission 220, a reservation for the same set of aggregated slots to retransmit the entire slot aggregated packet. In some cases, the first UE 115-c may reserve, via one or more SCI messages within the retransmission 220, one or more slots to retransmit the failed transport block.

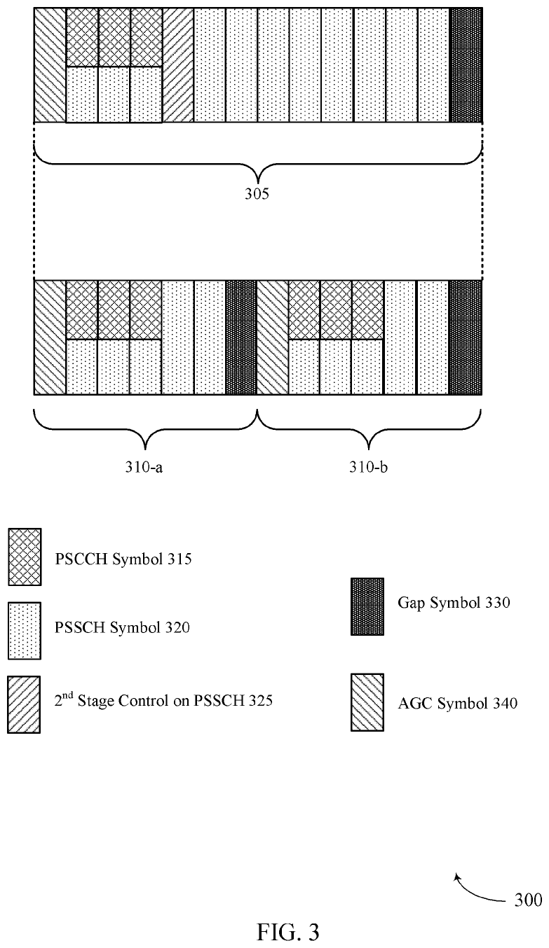

FIG. 3 illustrates an example of a slot format 300, for each of a slot 305 and one or more mini slots 310, that supports control signaling for transport blocks in slot aggregation in accordance with one or more aspects of the present disclosure. The slot format 300 may be implemented by aspects of the wireless communications systems 100 and 200. For example, the slot format 300 may be implemented by one or more UEs 115.

In sidelink communications, physical sidelink feedback channel (PSFCH) symbols may be configured with periods of 1, 2, or 4 slots, or may be fully disabled in a resources pool. Slot 305 illustrates an example slot spanning 14 OFDM symbols with PSFCH symbols disabled. The slot 305 includes an AGC symbol 340, PSCCH symbols 315, a second stage control on a PSSCH symbol 325 (e.g., an SCI-2), a gap symbol 330, and a quantity of PSSCH symbols 320 that may convey data.

A first mini slot 310-a and a second mini slot 310-b illustrate example mini slots each spanning 7 OFDM symbols. Accordingly, the first mini slot 310-a and the second mini slot 310-b together span the same quantity of symbols (14) as the slot 305. Each of the first mini slot 310-a and the second mini slot 310-b includes an AGC symbol 340, PSCCH symbols 315, a gap symbol 330, and a quantity of PSSCH symbols 320 that may convey data. Mini slots may be used to increase channel access opportunities within a given time duration. Additionally, or alternatively, use of mini slots may reduce the channel occupancy time for small transmissions, such as transmission control protocol (TCP) ACK. In some cases, mixing regular slots (e.g., with 14 OFDM symbols as shown by slot 305) and mini slots (e.g., with 7 slots as shown by the first mini slot 310-a and the second mini slot 310-b) may cause issues with AGC.

The AGC symbols 340, the PSCCH symbols 315, and the gap symbols 330 contribute to resource overhead (e.g., control overhead, DMRS overhead, AGC overhead, gap symbol overhead). The ratio of data symbols (e.g., PSSCH symbols 320) to symbols that contribute to resource overhead may be higher with mini slots as compared to slots such as the slot 305 with 14 OFDM symbols. For example, as shown in the slot format 300, 6 of the 14 symbols are used for control resources or gap symbols in the slot 305, while 10 of the 14 symbols are used for control resources cumulatively across the first mini slot 310-a and the second mini slot 310-b. To reduce the resource overhead associated with mini slots, mini slots may be aggregated.

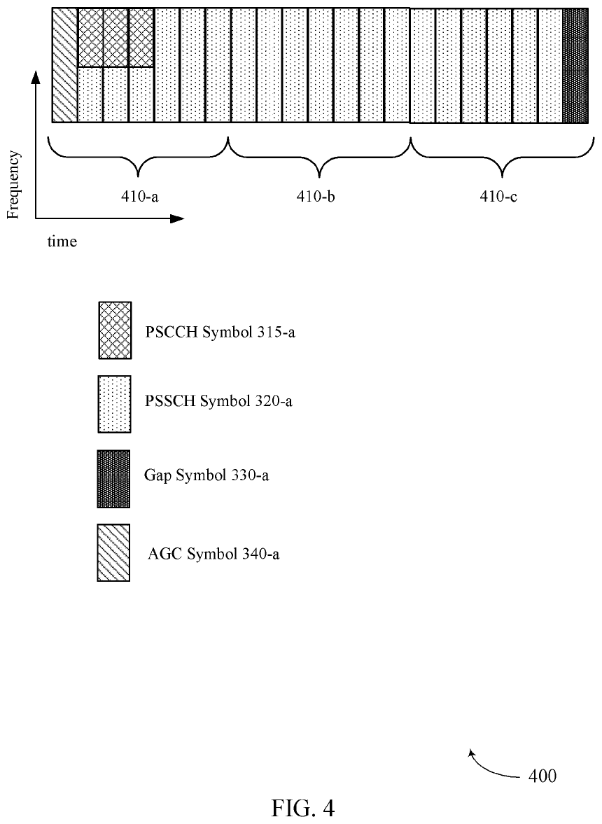

FIG. 4 illustrates an example of an aggregated slot format 400 that supports control signaling for transport blocks in slot aggregation in accordance with one or more aspects of the present disclosure. The aggregated slot format 400 may be implemented by aspects of the wireless communications systems 100 and 200. For example, the aggregated slot format 400 may be implemented by one or more UEs 115.

The aggregated slot format 400 includes three mini slots, a first mini slot 410-a, a second mini slot 410-b, and a third mini slot 410-c, which are aggregated together. Accordingly, as illustrated in the example aggregated slot format 400, the first mini slot 410-a includes an AGC symbol 340-a, and PSCCH symbols 315-a. The third mini slot 410-c may include a gap symbol 330-a at the end of the third mini slot 410-c. The AGC symbols, and PSCCH symbols, are removed from the second mini slot 410-b and the third mini slot 410-c, and the gap symbols may be removed from between the first mini slot 410-a and the second mini slot 410-b and from between the second mini slot 410-b and the third mini slot 410-c, because the information conveyed in the AGC symbol 340-a and the PSCCH symbols 315-a in the first mini slot 410-a may be applied to the second mini slot 410-b and the third mini slot 410-c. In some examples, the AGC symbols and gap symbols may be removed from between aggregated mini slots when an entire operating bandwidth allocated for sidelink communications between two UEs is used for the entire set of aggregated mini slots. Accordingly, the second mini slot 410-b and the third mini slot 410-c may include more PSSCH symbols 320-a that may convey data.

By including the control resources (e.g., the AGC symbol 340-a, and PSCCH symbols 315-a) in only the first mini slot 410-a and by removing gap symbols from between the aggregated mini slots, the fixed overhead associated with the AGC symbols, PSSCH symbols, and gap symbols may be reduced and amortized over the aggregated mini slots.

In some cases, for mini slot aggregation, the quantity of bits for TDRA reservation may be increased by 1 bit per reservation as compared with slots including 14 OFDM symbols. For example, for slots including 14 OFDM symbols, 5 bits may be used for 2 reservations, and 9 bits may be used for 3 reservations. For mini slots, 7 bits may be used for 2 reservations, and 12 bits may be used for 3 reservations. The TDRA may include a field indicating the beginning mini slot and another field indicating the quantity of slots in the slot aggregated packet, and accordingly a receiving UE may determine a reservation range corresponding to the slot aggregated packet. For mini slots, one more bit may be used per reservation as slot candidates may be selected within a time window (e.g., 32 candidate slots for slots having 14 OFDM symbols). 5 bits may be sufficient to represent 32 candidate slots. For mini slots, there would be 64 candidate mini slots within the same sized time window, and accordingly, an additional bit may be used to represent the larger quantity of candidate mini slots.

As described herein, in some examples, a receiving UE may indicate unsuccessful reception of one or more transport blocks of a slot aggregated packet (e.g., via transmitting a NACK). The transmitting UE may retransmit the transport block in response to receiving the NACK. For a retransmission, in some examples the transmitting UE may reserve the same set of aggregated slots and may retransmit the entire slot aggregated packet. In some examples, the transmitting UE may reserve a first slot for a retransmission, and may indicate via an SCI in the first slot of the retransmission a reservation of remaining slots for the retransmission. In some examples, the transmitting UE may retransmit less than all of the transport blocks in the slot aggregated packet (e.g., the transmitting UE may retransmit only the transport blocks that were not successfully received), which may allow for more flexibility in reservation of slots for retransmissions.

In some cases, when determining which slots to reserve for a slot aggregated packet, the transmitting UE may select the slots based on the slots satisfying one or more conditions. For example, if a slot (or mini slot) does not have a corresponding reference signal received power (RSRP) measurement above a threshold, the UE may not select the slot. For example, the following operations (1)-(7) may be used to determine a set of resources (e.g., slots) for a slot aggregated packet.
(1): A candidate single-slot resource for transmission R_{x,y} may be defined as a set of L_{subCH} contiguous sub-channels with sub-channel x+j in slot t′_{y}^{SL} where j=0, . . . , L_{subCH}−1. The UE may assume that any set of L_{subCH} contiguous sub-channels included in the corresponding resource pool within the time interval [n+T₁, n+T₂] correspond to one candidate single-slot resource, where: selection of T₁ is up to UE implementation under 0≤T₁≤T_{proc,1}^{SL}, where T_{proc,1}^{SL} is defined in slots in Table 2, where μ_{SL} is the subcarrier spacing (SCS) configuration of the sidelink BWP; and if T₂ₘᵢₙ is shorter than the remaining packet delay budget (in slots) then T₂ is up to UE implementation subject to T₂ₘᵢₙ≤T₂≤remaining packet delay budget (in slots); otherwise T₂ is set to the remaining packet delay budget (in slots). The total number of candidate single-slot resources is denoted by Mₜₒₜₐₗ.
(2): The sensing window may be defined by the range of slots [n−T₀, n−T_{proc,0}^{SL}) where T₀ is defined above and T_{proc,0}^{SL} is defined in slots in Table 1 where μ_{SL} is the SCS configuration of the sidelink BWP. The UE may monitor slots which belongs to a sidelink resource pool within the sensing window except for those in which its own transmissions occur. The UE may perform the following (3)-(7) based on PSCCH decoded and RSRP measured in these slots.
(3): The internal parameter Th(pᵢ,pⱼ) is set to the corresponding value of RSRP threshold indicated by the i-th field in sl-Thres-RSRP-List, where i=pᵢ+(pⱼ−1)*8.
(4): The set S_{A} is initialized to the set of all the candidate single-slot resources.
(5): The UE may exclude any candidate single-slot resource R_{x,y} from the set S_{A} if the candidate single-slot resource meets all the following conditions: the UE has not monitored slot t′ₘ^{SL} in (2), and for any periodicity value allowed by the higher layer parameter sl-ResourceReservePeriodList and a hypothetical SCI format 1-A received in slot t′ₘ^{SL} with ‘Resource reservation period’ field set to that periodicity value and indicating all subchannels of the resource pool in this slot, condition c in (6) would be met. If the number of candidate single-slot resources R_{x,y} remaining in the set S_{A} is smaller than X·Mₜₒₜₐₗ, the set S_{A} is initialized to the set of all the candidate single-slot resources as in (4).
(6): The UE may exclude any candidate single-slot resource R_{x,y} from the set S_{A} if candidate single-slot resource meets all the following conditions: (a) the UE receives an SCI format 1-A in slot t′ₘ^{SL}, and ‘Resource reservation period’ field, if present, and ‘Priority’ field in the received SCI format 1-A indicate the values P_{rsvp_RX} and prio_{RX}, respectively; (b) the RSRP measurement performed for the received SCI format 1-A, is higher than Th(prio_{RX}, prio_{TX}); (c) the SCI format received in slot t′ₘ^{SL} or the same SCI format which, if and only if the ‘Resource reservation period field’ is present in the received SCI format 1-A, is assumed to be received in slot(s) t′_{m+q×P′}_{_{rsvp_RX}}^{SL} determines the set of resource blocks and slots which overlaps with R_{x,y+j×P′}_{_{rsvp_TX}} for q=1, 2, . . . , [symbol] and j=0, 1, . . . , Cᵣₑₛₑₗ−1. Here, P′_{rsvp_RX} is P′_{rsvp_RX} converted to units of logical slots, Q=[T_{scal}/P_{rsvp_RX}] if P_{rsvp_RX}<T_{scal} and n′−m≤P′_{rsvp_RX}, where t′_{n′}^{SL}=n if slot n belongs to the set (t′₀^{SL}, t′₁^{SL}, . . . , t′_{T′}_{ₘₐₓ}₋₁^{SL}), otherwise slot t′_{n′}^{SL} is the first slot after slot n belonging to the set (t′₀^{SL}, t′₁^{SL}, . . . , t′_{T′}_{ₘₐₓ}₋₁^{SL}); otherwise Q=1. T_{scal} is set to selection window size T₂ converted to units of msec.
(7): If the number of candidate single-slot resources remaining in the set S_{A} is smaller than X·Mₜₒₜₐₗ, then Th(pᵢ,pⱼ) is increased by 3 dB for each priority value Th(pᵢ,pⱼ) and the procedure continues with (4).

TABLE 1

| μ_{SL} | T_{proc, 0}^{SL} [slots] |
|---|---|
| 0 | 1 |
| 1 | 1 |
| 2 | 2 |
| 3 | 4 |

TABLE 2

| μ_{SL} | T_{proc, 1}^{SL} [slots] |
|---|---|
| 0 | 3 |
| 1 | 5 |
| 2 | 9 |
| 3 | 17 |

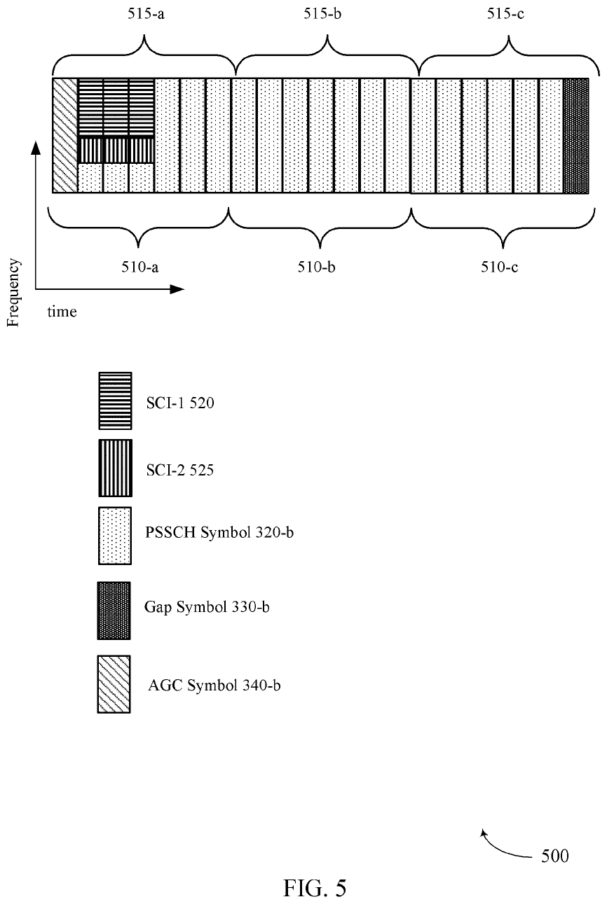

FIG. 5 illustrates an example of an aggregated slot format 500 that supports control signaling for transport blocks in slot aggregation in accordance with one or more aspects of the present disclosure. The aggregated slot format 500 may be implemented by aspects of the wireless communications systems 100 and 200. For example, the aggregated slot format 500 may be implemented by one or more UEs 115.

The aggregated slot format 500 includes three slots (e.g., mini slots), including a first slot 510-a, a second slot 510-b, and a third slot 510-c. which are aggregated together. In some examples, each slot (e.g., the first slot 510-a, the second slot 510-b, and the third slot 510-c) may correspond to a transport block. For example, a first transport block 515-a may span the first slot 510-a, a second transport block 515-b may span the second slot 510-b, and a third transport block 515-c may span the third slot 510-c. In some examples, transport blocks may be unevenly distributed across slots (e.g., the first transport block 515-a may span the first slot 510-a and the second slot 510-b, and the second transport block 515-b may span the third slot 510-c). As illustrated in the example aggregated slot format 500, the first slot 510-a includes an AGC symbol 340-b. The third slot 510-c may include a gap symbol 330-b at the end of the third slot 510-c. The first slot 510-a, the second slot 510-b, and the third slot 510-c may include more PSSCH symbols 320-b that may convey data.

An SCI-1 520 (which may span multiple symbols) may indicate common scheduling parameters that are common to the multiple transport blocks (e.g., the first transport block 515-a, the second transport block 515-b, and the third transport block 515-c). For example, if the transport blocks include a common MCS, the SCI-1 520 may include an indication of the common MCS. As the quantity of bits in the SCI-1 520 may be limited, one or more SCI-2 525 may indicate additional scheduling parameters for the multiple transport blocks (e.g., the first transport block 515-a, the second transport block 515-b, and the third transport block 515-c). As shown in the aggregated slot format 500, in some examples, the one or more SCI-2 may be included in the first slot 510-a.

In some cases, as shown in the aggregated slot format 500, multiple SCI-2s with the same format may include information for the multiple transport blocks. For example, a first SCI-2 525 may include additional scheduling parameters for the first transport block 515-a, a second SCI-2 525 may include additional scheduling parameters for the second transport block 515-b, and a third SCI-2 525 may include additional scheduling parameters for the third transport block 515-c. The SCI-1 520 may include an indication of the common format for the multiple SCI-2s 525.

In some cases, a single SCI-2 525 may include additional scheduling parameters for the multiple transport blocks (e.g., the first transport block 515-a, the second transport block 515-b, and the third transport block 515-c). For example, for any given field in the SCI-2 525, the given field may include a corresponding value for each of the transport blocks (e.g., the first transport block 515-a, the second transport block 515-b, and the third transport block 515-c). For example, the single SCI-2 may include a first TDRA value for the first transport block 515-a, a second TDRA value for the second transport block 515-b, and a third TDRA value for the third transport block 515-c. As another example, the single SCI-2 may include a first MCS for the first transport block 515-a, a second MCS for the second transport block 515-b, and a third MCS for the third transport block 515-c. As another example, the single SCI-2 may include a first priority for the first transport block 515-a, a second priority for the second transport block 515-b, and a third priority for the third transport block 515-c. In some examples, which fields in the SCI-2 include multiple values (e.g., for the multiple transport blocks) may be preconfigured. In some examples, which fields in the SCI-2 include multiple values may be indicated by the SCI-1 520 or the SCI-2 525.

In some cases, the transmitting UE may indicate, via an SCI-1 520 or an SCI-2 525, the FDRA and/or TDRA for the entire slot aggregated packet. In some examples, SCI-2 525 may indicate the FDRA and/or TDRA for each individual transport block (e.g., the first transport block 515-a, the second transport block 515-b, and the third transport block 515-c). For example, fields in the SCI-2(s) 525 may indicate time domain offsets for the transport blocks, FDRA, TDRA, or a combination thereof, particularly when transport blocks sizes within a slot aggregated packet are non-uniform. The indication of the FDRA and TDRA on a per-transport block basis may be used for decoding the transport blocks. The indication of the FDRA and TDRA on a per-transport block basis may also be used for other UEs (e.g., UEs other than the receiving UE and the transmitting UE) to decide whether to reserve the same FDRAs and TDRAs.

In some cases, the SCI-1 520 may indicate a reservation period for the slot aggregated packet, which may apply to all aggregated slots (e.g., the first slot 510-a, the second slot 510-b, and the third slot 510-c). In some examples, the SCI-1 520 may indicate a reservation period for the first slot 510-a or first transport block 515-a, and for each subsequent transport block (e.g., the second transport block 515-b and the third transport block 515-c), an SCI-2 525 corresponding to that transport block may indicate the reservation period.

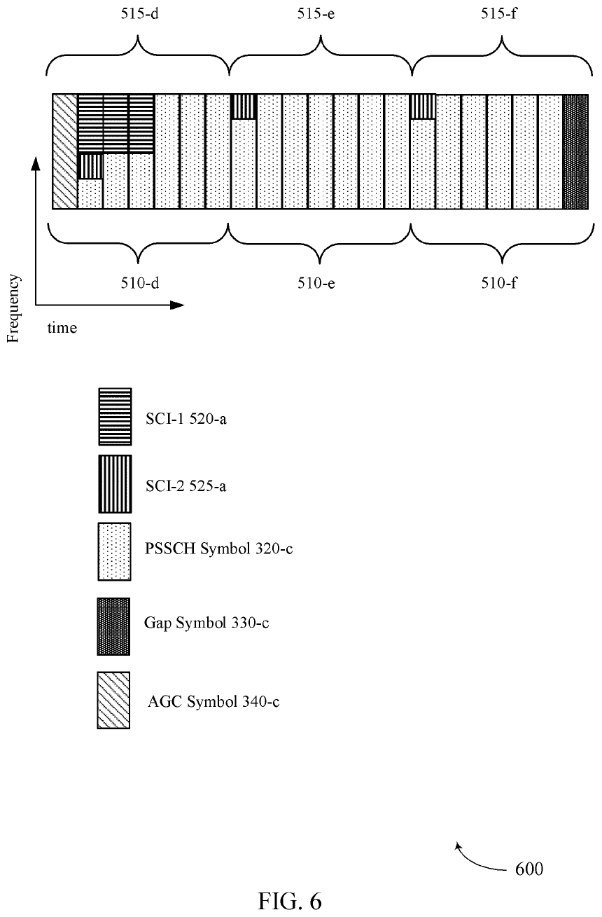

FIG. 6 illustrates an example of an aggregated slot format 600 that supports control signaling for transport blocks in slot aggregation in accordance with one or more aspects of the present disclosure. The aggregated slot format 600 may be implemented by aspects of the wireless communications systems 100 and 200. For example, the aggregated slot format 600 may be implemented by one or more UEs 115.

The aggregated slot format 600 includes three slots (e.g., mini slots), including a first slot 510-d, a second slot 510-e, and a third slot 510-f. which are aggregated together. In some examples, each slot (e.g., the first slot 510-d, the second slot 510-e, and the third slot 510-f) may correspond to a transport block. For example, a first transport block 515-d may span the first slot 510-d, a second transport block 515-e may span the second slot 510-e, and a third transport block 515-f may span the third slot 510-f. In some examples, transport blocks may be unevenly distributed across slots (e.g., the first transport block 515-d may span the first slot 510-d and the second slot 510-e, and the second transport block 515-e may span the third slot 510-f). As illustrated in the example aggregated slot format 500, the first slot 510-d includes an AGC symbol 340-c. The third slot 510-f may include a gap symbol 330-c at the end of the third slot 510-f. The first slot 510-d, the second slot 510-e, and the third slot 510-f may include more PSSCH symbols 320-c that may convey data.

An SCI-1 520-a (which may span multiple symbols) may indicate common scheduling parameters that are common to the multiple transport blocks (e.g., the first transport block 515-d, the second transport block 515-e, and the third transport block 515-f). For example, if the transport blocks include a common MCS, the SCI-1 520-a may include an indication of the common MCS. As the quantity of bits in the SCI-1 may be limited, SCI-2s 525-a may indicate additional scheduling parameters for the multiple transport blocks (e.g., the first transport block 515-d, the second transport block 515-e, and the third transport block 515-f). As shown in the aggregated slot format 600, each transport block (e.g., the first transport block 515-d, the second transport block 515-e, and the third transport block 515-f) may include an SCI-2 525-a. For example, placing the SCI-2(s) conveying the additional scheduling parameters for all of the transport blocks in the first transport block may result in an unbalanced data load between the different transport blocks (e.g., the first transport block may include less data).

In some examples, the SCI-2 525-a in the first transport block 515-d may include a first TDRA value for the first transport block 515-a, the SCI-2 in the second transport block 515-e may include a second TDRA value for the second transport block 515-e, and the SCI-2 525-a in the third transport block 515-f may include a third TDRA value for the third transport block 515-f. In some examples, the SCI-2 in the first transport block 515-d may include a first MCS for the first transport block 515-a, the SCI-2 in the second transport block 515-e may include a second MCS for the second transport block 515-e, and the SCI-2 525-a in the third transport block 515-f may include a third MCS for the third transport block 515-f. In some examples, the SCI-2 in the first transport block 515-d may include a first priority for the first transport block 515-a, the SCI-2 in the second transport block 515-e may include a second priority for the second transport block 515-e, and the SCI-2 525-a in the third transport block 515-f may include a third priority for the third transport block 515-f.

In some cases, the SCI-2s 525-a in the different transport blocks may have the same format, which may be indicated by an SCI-2 format indicator in the SCI-1 520-a. In some examples, the SCI-2s 525-a in the different transport blocks may have different formats. For example, an SCI-2 format indicator in the SCI-1 520-a may indicate the format of the SCI-2 525-a in the first transport block 515-d. In some examples, the SCI-2 525-a in the first transport block 515-d may indicate the format for the remainder of the SCI-2s (e.g., the SCI-2 525-a in the second transport block 515-e and the SCI-2 525-a in the third transport block 515-f). In some examples, the SCI-2 525-a in each transport block may indicate the SCI-2 format for the subsequent transport block (e.g., the SCI-2 525-a in the first transport block 515-d may indicate the format for the SCI-2 525-a in the second transport block 515-e, and the SCI-2 525-a in the second transport block 515-e may indicate the format for the SCI-2 525-a in the third transport block 515-f).

In some cases, the SCI-2s 525-a in the transport blocks after the first transport block 515-d may indicate delta information with respect to the SCI-2 525-a in the first transport block 515-d, which may include some scheduling information common to all of the transport blocks (e.g., the first transport block 515-d, the second transport block 515-e, and the third transport block 515-f). For example, a source identifier may be common to all of the transport blocks (as the same UE is transmitting all of the transport blocks), and accordingly the source identifier may be included in the SCI-2 525-a in the first transport block 515-d but not in the remaining SCI-2s 525-a. Accordingly, the bit-size of the SCI-2s in subsequent transport blocks may be reduced. In some cases, some fields in the SCI-2 525-a in the first transport block 515-d may be used as a reference, and the same fields in SCI-2s 525-a in subsequent transport blocks (e.g., the second transport block 515-e and the third transport block 515-f) may be differential with respect to the reference fields in the SCI-2 525-a in the first transport block 515-d. For example, for the MCS field, the MCS field in the SCI-2 525-a in the first transport block 515-d may be used as a reference, and the quantity of bits in the SCI-2s 525-a in the second transport block 515-e and the third transport block 515-f for the respective MCS fields may be reduced by half by indicating a differential value with respect to the reference MCS.

In some cases, the SCI-1 520-a may indicate a reservation period for the slot aggregated packet, which may apply to all aggregated slots (e.g., the first slot 510-d, the second slot 510-e, and the third slot 510-f). In some examples, the SCI-1 520-a may indicate a reservation period for the first slot 510-d or first transport block 515-d, and for each subsequent transport block (e.g., the second transport block 515-e and the third transport block 515-f), an SCI-2 within that transport block may indicate the reservation period.

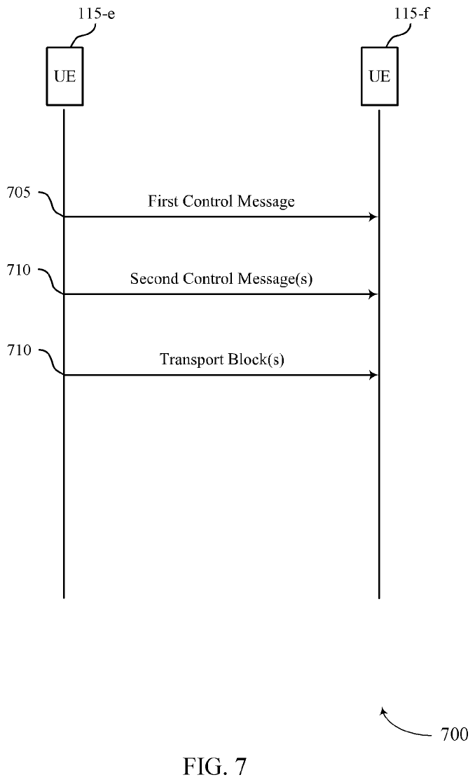

FIG. 7 illustrates an example of a process flow 700 that supports control signaling for transport blocks in slot aggregation in accordance with one or more aspects of the present disclosure. The process flow 700 may include a first UE 115-e and a second UE 115-f, which may be examples of a UE 115 as described herein. In the following description of the process flow 700, the operations between the first UE 115-e and the second UE 115-f may be transmitted in a different order than the example order shown, or the operations performed by the first UE 115-e and the second UE 115-f may be performed in different orders or at different times. Some operations may also be omitted from the process flow 700, and other operations may be added to the process flow 700.

At 705, the first UE 115-e may transmit, to the second UE 115-f, a first control message (e.g., a sidelink control message) such as a first-stage SCI message associated with a set of multiple transport blocks, the first-stage SCI message indicating a common set of scheduling parameters common to the set of multiple transport blocks.

At 710, the first UE 115-e may transmit, to the second UE 115-f, a second control message (e.g., a sidelink control message), such as at least one second-stage SCI message that indicates additional scheduling parameters for the set of multiple transport blocks.

At 715, the first UE 115-e may transmit, to the second UE 115-f, one or more transport blocks. For example, the first UE 115-e may transmit the set of multiple transport blocks via a set of multiple aggregated slots in accordance with the common set of scheduling parameters and the additional scheduling parameters.

In some examples, transmitting the at least one second-stage SCI message may include transmitting, via a temporally first slot of the set of multiple aggregated slots, a set of multiple second-stage SCI messages for the set of multiple transport blocks. In some cases, transmitting the first-stage SCI message may include transmitting an indication of a common format for the set of multiple second-stage SCI messages.

In some examples, transmitting the at least one second-stage SCI message may include transmitting a single second-stage SCI message via a temporally first slot of the set of multiple aggregated slots, the single second-stage SCI message including a set of multiple sets of additional scheduling parameters for the set of multiple transport blocks.

In some examples, transmitting the at least one second-stage SCI message may include: transmitting, via a first transport block of the set of multiple transport blocks, a first second-stage SCI message for the first transport block, and transmitting, via a second transport block of the set of multiple transport blocks, a second second-stage SCI message for the second transport block. In some examples, transmitting the first-stage SCI message may include transmitting an indication of a common format for the first second-stage SCI message and the second second-stage SCI message. In some examples, transmitting the first-stage SCI message may include transmitting an indication of a first format for the first second-stage SCI message, where the first second-stage SCI message comprises an indication of a second format for the second second-stage SCI message. In some examples, transmitting the first-stage SCI message may include transmitting an indication of a first format for the first second-stage SCI message, where the first second-stage SCI message comprises an indication of a second format for the second second-stage SCI message, and where the second second-stage SCI message comprises an indication of a third format for a third second-stage SCI message for a third transport block of the set of multiple transport blocks.

In some examples, transmitting the at least one second-stage SCI message may include: transmitting, via a temporally first slot of the set of multiple aggregated slots, a first second-stage SCI message for a temporally first transport block of the set of multiple transport blocks, the first second-stage SCI message including at least one scheduling parameter common to the set of multiple transport blocks; and transmitting, via a second transport block of the set of multiple transport blocks, a second second-stage SCI message including at least one scheduling parameter for the second transport block.

In some examples, transmitting the first-stage SCI message may include transmitting the first-stage SCI message via a temporally first slot of the set of multiple aggregated slots.

In some examples, the additional scheduling parameters comprise one or more destination identifiers for the set of multiple transport blocks, one or more modulation and coding schemes for the set of multiple transport blocks, one or more TDRAs for the set of multiple transport blocks, or a combination thereof.

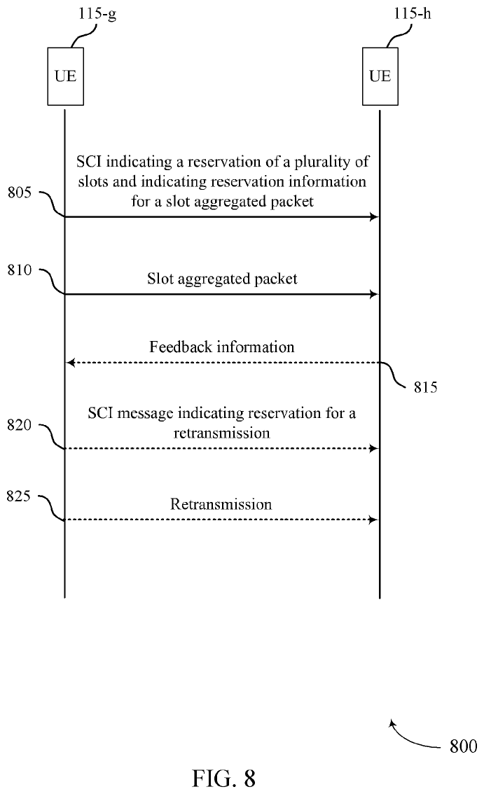

FIG. 8 illustrates an example of a process flow 800 that supports control signaling for transport blocks in slot aggregation in accordance with one or more aspects of the present disclosure. The process flow 800 may include a first UE 115-g and a second UE 115-h, which may be examples of a UE 115 as described herein. In the following description of the process flow 800, the operations between the first UE 115-g and the second UE 115-h may be transmitted in a different order than the example order shown, or the operations performed by the first UE 115-g and the second UE 115-h may be performed in different orders or at different times. Some operations may also be omitted from the process flow 800, and other operations may be added to the process flow 800.

At 805, the first UE 115-g may transmit, to the second UE 115-h, a first SCI message indicating a reservation of a set of multiple slots and indicating reservation information for a slot aggregated packet that is aggregated across one or more slots of the set of multiple slots, the slot aggregated packet including one or more transport blocks.

At 810, the first UE 115-g may transmit, to the second UE 115-h, the slot aggregated packet via the set of multiple slots based on the reservation information.

In some examples, transmitting the first SCI message indicating the reservation of the set of multiple slots may include transmitting an indication of a beginning slot and a quantity of slots.

In some examples, the reservation information includes a respective TDRA and FDRA for the one or more transport blocks.

In some examples, transmitting the first SCI message indicating the reservation of the set of multiple slots may include transmitting an indication of a beginning slot, and where respective second SCI messages transmitted via respective transport blocks of the one or more transport blocks indicate respective reservation information for the respective transport blocks.

In some examples, the first UE 115-g may select the set of multiple slots based on the set of multiple slots satisfying one or more conditions.

In some examples, at 815, the second UE 115-h may transmit, to the first UE 115-g, feedback information indicating unsuccessful reception of a transport block of the slot aggregated packet.

In some examples, at 820, the first UE 115-g may transmit, to the second UE 115-h, a second SCI message indicting a reservation for a retransmission of the transport block based on the feedback information.

In some examples, at 825, the first UE 115-g, may transmit, to the second UE 115-h, a retransmission of the transport block in accordance with the reservation.

In some examples, the second SCI message at 820 may indicate a reservation of a set of multiple slots and reservation information for a retransmission of the entire slot aggregated packet, and at 825 the first UE 115-g may retransmit the entire slot aggregated packet. The reserved slots and the reservation information may be the same as the original slot aggregated packet at 810.

In some examples, the second SCI message at 820 may indicate a reservation of a slot for retransmission of the failed transport block, and in the slot, the first UE 115-g may transmit an indication of second reservation information for the retransmission of the transport block. At 825, the first UE 115-g may retransmit the failed transport block (e.g., and may not retransmit transport blocks of the slot aggregated packet which were successfully received by the second UE 115-h).

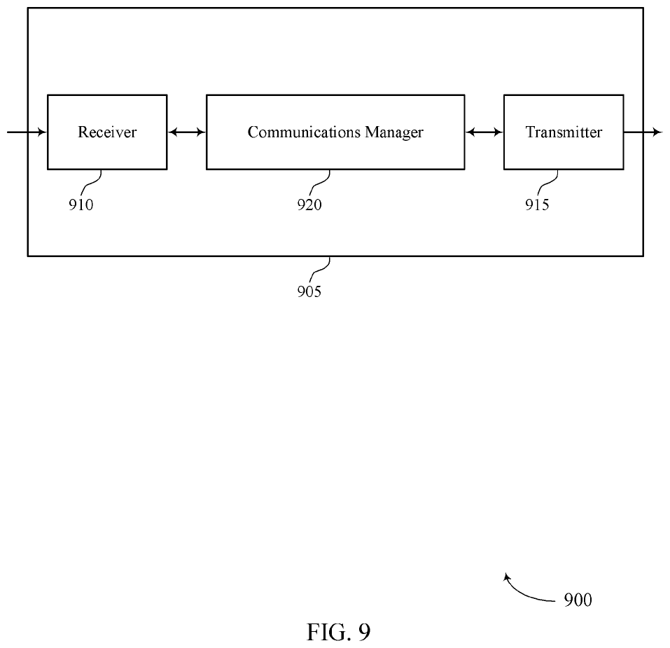

FIG. 9 shows a block diagram 900 of a device 905 that supports control signaling for transport blocks in slot aggregation in accordance with one or more aspects of the present disclosure. The device 905 may be an example of aspects of a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to control signaling for transport blocks in slot aggregation). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to control signaling for transport blocks in slot aggregation). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of control signaling for transport blocks in slot aggregation as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications at a first UE in accordance with examples as disclosed herein. For example, the communications manager 920 may be configured as or otherwise support a means for transmitting, to a second UE, a first-stage SCI message associated with a set of multiple transport blocks, the first-stage SCI message indicating a common set of scheduling parameters common to the set of multiple transport blocks. The communications manager 920 may be configured as or otherwise support a means for transmitting, to the second UE, at least one second-stage SCI message that indicates additional scheduling parameters for the set of multiple transport blocks. The communications manager 920 may be configured as or otherwise support a means for transmitting, to the second UE, the set of multiple transport blocks via a set of multiple aggregated slots in accordance with the common set of scheduling parameters and the additional scheduling parameters.

Additionally, or alternatively, the communications manager 920 may support wireless communications at a second UE in accordance with examples as disclosed herein. For example, the communications manager 920 may be configured as or otherwise support a means for receiving, from a first UE, a first-stage SCI message associated with a set of multiple transport blocks, the first-stage SCI message indicating a common set of scheduling parameters common to the set of multiple transport blocks. The communications manager 920 may be configured as or otherwise support a means for receiving, from the first UE, at least one second-stage SCI message that indicates additional scheduling parameters the set of multiple transport blocks. The communications manager 920 may be configured as or otherwise support a means for receiving, from the first UE, the set of multiple transport blocks via a set of multiple aggregated slots in accordance with the common set of scheduling parameters and the additional scheduling parameters.

Additionally, or alternatively, the communications manager 920 may support wireless communications at a first UE in accordance with examples as disclosed herein. For example, the communications manager 920 may be configured as or otherwise support a means for transmitting, to a second UE, a first SCI message indicating a reservation of a set of multiple slots and indicating reservation information for a slot aggregated packet that is aggregated across one or more slots of the set of multiple slots, the slot aggregated packet including one or more transport blocks. The communications manager 920 may be configured as or otherwise support a means for transmitting, to the second UE, the slot aggregated packet via the set of multiple slots based on the reservation information.

Additionally, or alternatively, the communications manager 920 may support wireless communications at a second UE in accordance with examples as disclosed herein. For example, the communications manager 920 may be configured as or otherwise support a means for receiving, from a first UE, a first SCI message indicating a reservation of a set of multiple slots and indicating reservation information for a slot aggregated packet that is aggregated across one or more slots of the set of multiple slots, the slot aggregated packet including one or more transport blocks. The communications manager 920 may be configured as or otherwise support a means for receiving, from the first UE, the slot aggregated packet via the set of multiple slots based on the reservation information.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for more efficient utilization of communication resources.

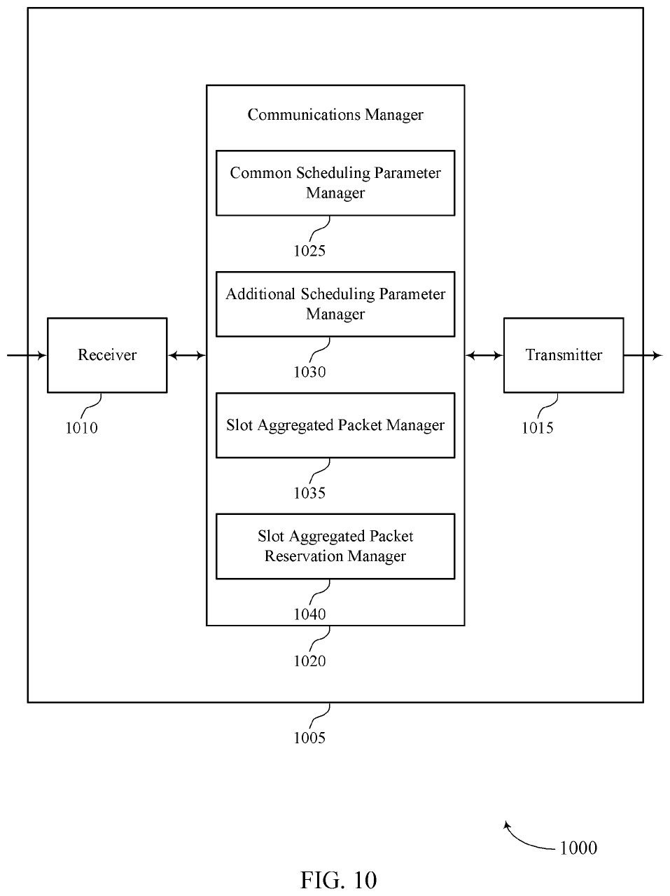

FIG. 10 shows a block diagram 1000 of a device 1005 that supports control signaling for transport blocks in slot aggregation in accordance with one or more aspects of the present disclosure. The device 1005 may be an example of aspects of a device 905 or a UE 115 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to control signaling for transport blocks in slot aggregation). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to control signaling for transport blocks in slot aggregation). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of control signaling for transport blocks in slot aggregation as described herein. For example, the communications manager 1020 may include a common scheduling parameter manager 1025, an additional scheduling parameter manager 1030, a slot aggregated packet manager 1035, a slot aggregated packet reservation manager 1040, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a first UE in accordance with examples as disclosed herein. The common scheduling parameter manager 1025 may be configured as or otherwise support a means for transmitting, to a second UE, a first-stage SCI message associated with a set of multiple transport blocks, the first-stage SCI message indicating a common set of scheduling parameters common to the set of multiple transport blocks. The additional scheduling parameter manager 1030 may be configured as or otherwise support a means for transmitting, to the second UE, at least one second-stage SCI message that indicates additional scheduling parameters for the set of multiple transport blocks. The slot aggregated packet manager 1035 may be configured as or otherwise support a means for transmitting, to the second UE, the set of multiple transport blocks via a set of multiple aggregated slots in accordance with the common set of scheduling parameters and the additional scheduling parameters.

Additionally, or alternatively, the communications manager 1020 may support wireless communications at a second UE in accordance with examples as disclosed herein. The common scheduling parameter manager 1025 may be configured as or otherwise support a means for receiving, from a first UE, a first-stage SCI message associated with a set of multiple transport blocks, the first-stage SCI message indicating a common set of scheduling parameters common to the set of multiple transport blocks. The additional scheduling parameter manager 1030 may be configured as or otherwise support a means for receiving, from the first UE, at least one second-stage SCI message that indicates additional scheduling parameters the set of multiple transport blocks. The slot aggregated packet manager 1035 may be configured as or otherwise support a means for receiving, from the first UE, the set of multiple transport blocks via a set of multiple aggregated slots in accordance with the common set of scheduling parameters and the additional scheduling parameters.

Additionally, or alternatively, the communications manager 1020 may support wireless communications at a first UE in accordance with examples as disclosed herein. The slot aggregated packet reservation manager 1040 may be configured as or otherwise support a means for transmitting, to a second UE, a first SCI message indicating a reservation of a set of multiple slots and indicating reservation information for a slot aggregated packet that is aggregated across one or more slots of the set of multiple slots, the slot aggregated packet including one or more transport blocks. The slot aggregated packet manager 1035 may be configured as or otherwise support a means for transmitting, to the second UE, the slot aggregated packet via the set of multiple slots based on the reservation information.

Additionally, or alternatively, the communications manager 1020 may support wireless communications at a second UE in accordance with examples as disclosed herein. The slot aggregated packet reservation manager 1040 may be configured as or otherwise support a means for receiving, from a first UE, a first SCI message indicating a reservation of a set of multiple slots and indicating reservation information for a slot aggregated packet that is aggregated across one or more slots of the set of multiple slots, the slot aggregated packet including one or more transport blocks. The slot aggregated packet manager 1035 may be configured as or otherwise support a means for receiving, from the first UE, the slot aggregated packet via the set of multiple slots based on the reservation information.

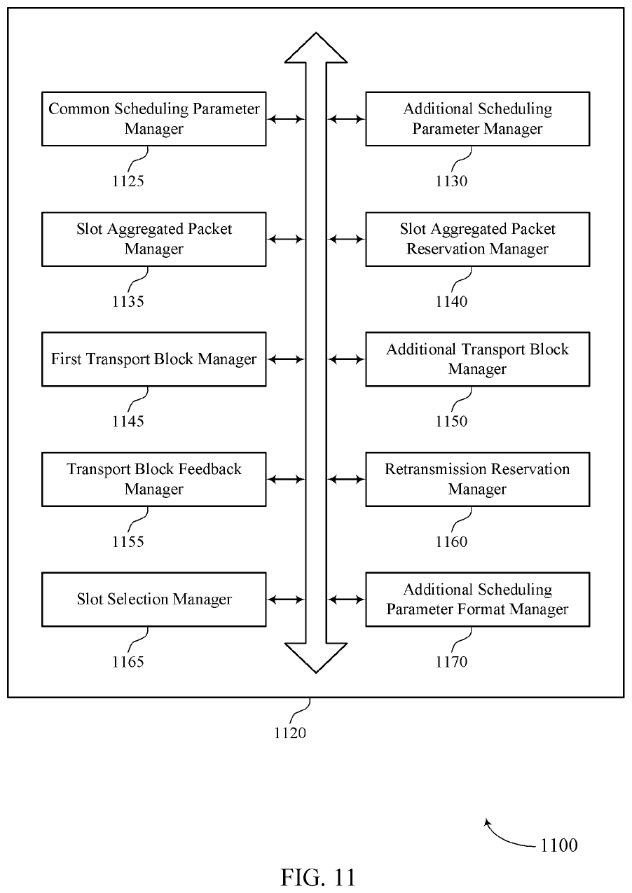

FIG. 11 shows a block diagram 1100 of a communications manager 1120 that supports control signaling for transport blocks in slot aggregation in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of control signaling for transport blocks in slot aggregation as described herein. For example, the communications manager 1120 may include a common scheduling parameter manager 1125, an additional scheduling parameter manager 1130, a slot aggregated packet manager 1135, a slot aggregated packet reservation manager 1140, a first transport block manager 1145, an additional transport block manager 1150, a transport block feedback manager 1155, a retransmission reservation manager 1160, a slot selection manager 1165, an additional scheduling parameter format manager 1170, or any combination thereof. Each of these components may communicate, directly or indirectly, with one another (e.g., via one or more buses).

The communications manager 1120 may support wireless communications at a first UE in accordance with examples as disclosed herein. The common scheduling parameter manager 1125 may be configured as or otherwise support a means for transmitting, to a second UE, a first-stage SCI message associated with a set of multiple transport blocks, the first-stage SCI message indicating a common set of scheduling parameters common to the set of multiple transport blocks. The additional scheduling parameter manager 1130 may be configured as or otherwise support a means for transmitting, to the second UE, at least one second-stage SCI message that indicates additional scheduling parameters for the set of multiple transport blocks. The slot aggregated packet manager 1135 may be configured as or otherwise support a means for transmitting, to the second UE, the set of multiple transport blocks via a set of multiple aggregated slots in accordance with the common set of scheduling parameters and the additional scheduling parameters.

In some examples, to support transmitting the at least one second-stage SCI message, the additional scheduling parameter manager 1130 may be configured as or otherwise support a means for transmitting, via a temporally first slot of the set of multiple aggregated slots, a set of multiple second-stage SCI messages for the set of multiple transport blocks.

In some examples, to support transmitting the first-stage SCI message, the additional scheduling parameter format manager 1170 may be configured as or otherwise support a means for transmitting an indication of a common format for the set of multiple second-stage SCI messages.

In some examples, to support transmitting the at least one second-stage SCI message, the first transport block manager 1145 may be configured as or otherwise support a means for transmitting a single second-stage SCI message via a temporally first slot of the set of multiple aggregated slots, the single second-stage SCI message including a set of multiple sets of additional scheduling parameters for the set of multiple transport blocks.

In some examples, to support transmitting the at least one second-stage SCI message, the first transport block manager 1145 may be configured as or otherwise support a means for transmitting, via a first transport block of the set of multiple transport blocks, a first second-stage SCI message for the first transport block. In some examples, to support transmitting the at least one second-stage SCI message, the additional transport block manager 1150 may be configured as or otherwise support a means for transmitting, via a second transport block of the set of multiple transport blocks, a second second-stage SCI message for the second transport block.

In some examples, to support transmitting the first-stage SCI message, the additional scheduling parameter format manager 1170 may be configured as or otherwise support a means for transmitting an indication of a common format for the first second-stage SCI message and the second second-stage SCI message.

In some examples, to support transmitting the first-stage SCI message, the additional scheduling parameter format manager 1170 may be configured as or otherwise support a means for transmitting an indication of a first format for the first second-stage SCI message, where the first second-stage SCI message includes an indication of a second format for the second second-stage SCI message.

In some examples, to support transmitting the first-stage SCI message, the additional scheduling parameter format manager 1170 may be configured as or otherwise support a means for transmitting an indication of a first format for the first second-stage SCI message, where the first second-stage SCI message includes an indication of a second format for the second second-stage SCI message, and where the second second-stage SCI message includes an indication of a third format for a third second-stage SCI message for a third transport block of the set of multiple transport blocks.

In some examples, to support transmitting the at least one second-stage SCI message, the first transport block manager 1145 may be configured as or otherwise support a means for transmitting, via a temporally first slot of the set of multiple aggregated slots, a first second-stage SCI message for a temporally first transport block of the set of multiple transport blocks, the first second-stage SCI message including at least one scheduling parameter common to the set of multiple transport blocks. In some examples, to support transmitting the at least one second-stage SCI message, the additional transport block manager 1150 may be configured as or otherwise support a means for transmitting, via a second transport block of the set of multiple transport blocks, a second second-stage SCI message including at least one scheduling parameter for the second transport block.

In some examples, to support transmitting the first-stage SCI message, the first transport block manager 1145 may be configured as or otherwise support a means for transmitting the first-stage SCI message via a temporally first slot of the set of multiple aggregated slots.

In some examples, the additional scheduling parameters include one or more destination identifiers for the set of multiple transport blocks, one or more modulation and coding schemes for the set of multiple transport blocks, one or more TDRAs for the set of multiple transport blocks, or a combination thereof.

Additionally, or alternatively, the communications manager 1120 may support wireless communications at a second UE in accordance with examples as disclosed herein. In some examples, the common scheduling parameter manager 1125 may be configured as or otherwise support a means for receiving, from a first UE, a first-stage SCI message associated with a set of multiple transport blocks, the first-stage SCI message indicating a common set of scheduling parameters common to the set of multiple transport blocks. In some examples, the additional scheduling parameter manager 1130 may be configured as or otherwise support a means for receiving, from the first UE, at least one second-stage SCI message that indicates additional scheduling parameters the set of multiple transport blocks. In some examples, the slot aggregated packet manager 1135 may be configured as or otherwise support a means for receiving, from the first UE, the set of multiple transport blocks via a set of multiple aggregated slots in accordance with the common set of scheduling parameters and the additional scheduling parameters.

In some examples, to support receiving the at least one second-stage SCI message, the additional scheduling parameter manager 1130 may be configured as or otherwise support a means for receiving, via a temporally first slot of the set of multiple aggregated slots, a set of multiple second-stage SCI messages for the set of multiple transport blocks.

In some examples, to support receiving the first-stage SCI message, the additional scheduling parameter format manager 1170 may be configured as or otherwise support a means for receiving an indication of a common format for the set of multiple second-stage SCI messages.

In some examples, to support receiving the at least one second-stage SCI message, the first transport block manager 1145 may be configured as or otherwise support a means for receiving a single second-stage SCI message via a temporally first slot of the set of multiple aggregated slots, the single second-stage SCI message including a set of multiple sets of additional scheduling parameters for the set of multiple transport blocks.

In some examples, to support receiving the at least one second-stage SCI message, the first transport block manager 1145 may be configured as or otherwise support a means for receiving, via a first transport block of the set of multiple transport blocks, a first second-stage SCI message for the first transport block. In some examples, to support receiving the at least one second-stage SCI message, the additional transport block manager 1150 may be configured as or otherwise support a means for receiving, via a second transport block of the set of multiple transport blocks, a second second-stage SCI message for the second transport block.

In some examples, to support receiving the first-stage SCI message, the additional scheduling parameter format manager 1170 may be configured as or otherwise support a means for receiving an indication of a common format for the first second-stage SCI message and the second second-stage SCI message.

In some examples, to support receiving the first-stage SCI message, the additional scheduling parameter format manager 1170 may be configured as or otherwise support a means for receiving an indication of a first format for the first second-stage SCI message, where the first second-stage SCI message includes an indication of a second format for the second second-stage SCI message.

In some examples, to support receiving the first-stage SCI message, the additional scheduling parameter format manager 1170 may be configured as or otherwise support a means for receiving an indication of a first format for the first second-stage SCI message, where the first second-stage SCI message includes an indication of a second format for the second second-stage SCI message, and where the second second-stage SCI message includes an indication of a third format for a third second-stage SCI message for a third transport block of the set of multiple transport blocks.

In some examples, to support receiving the at least one second-stage SCI message, the first transport block manager 1145 may be configured as or otherwise support a means for receiving, via a temporally first slot of the set of multiple aggregated slots, a first second-stage SCI message for a temporally first transport block of the set of multiple transport blocks, the first second-stage SCI message including at least one scheduling parameter common to the set of multiple transport blocks. In some examples, to support receiving the at least one second-stage SCI message, the additional transport block manager 1150 may be configured as or otherwise support a means for receiving, via a second transport block of the set of multiple transport blocks, a second second-stage SCI message including at least one scheduling parameter for the second transport block.

In some examples, to support receiving the first-stage SCI message, the first transport block manager 1145 may be configured as or otherwise support a means for receiving the first-stage SCI message via a temporally first slot of the set of multiple aggregated slots.

In some examples, the additional scheduling parameters include one or more destination identifiers for the set of multiple transport blocks, one or more modulation and coding schemes for the set of multiple transport blocks, one or more TDRAs for the set of multiple transport blocks, or a combination thereof.

Additionally, or alternatively, the communications manager 1120 may support wireless communications at a first UE in accordance with examples as disclosed herein. The slot aggregated packet reservation manager 1140 may be configured as or otherwise support a means for transmitting, to a second UE, a first SCI message indicating a reservation of a set of multiple slots and indicating reservation information for a slot aggregated packet that is aggregated across one or more slots of the set of multiple slots, the slot aggregated packet including one or more transport blocks. In some examples, the slot aggregated packet manager 1135 may be configured as or otherwise support a means for transmitting, to the second UE, the slot aggregated packet via the set of multiple slots based on the reservation information.

In some examples, to support transmitting the first SCI message indicating the reservation of the set of multiple slots, the slot aggregated packet reservation manager 1140 may be configured as or otherwise support a means for transmitting an indication of a beginning slot and a quantity of slots.

In some examples, the transport block feedback manager 1155 may be configured as or otherwise support a means for receiving, from the second UE, feedback indicating unsuccessful reception of a transport block of the slot aggregated packet. In some examples, the retransmission reservation manager 1160 may be configured as or otherwise support a means for transmitting, to the second UE and in response to the feedback, a second SCI message indicating a second reservation of a second set of multiple slots and second reservation information for a retransmission of the slot aggregated packet, the second reservation corresponding to the reservation and the second reservation information corresponding to the reservation information.

In some examples, the transport block feedback manager 1155 may be configured as or otherwise support a means for receiving, from the second UE, feedback indicating unsuccessful reception of a transport block of the slot aggregated packet. In some examples, the retransmission reservation manager 1160 may be configured as or otherwise support a means for transmitting, to the second UE and in response to the feedback, a second SCI message indicating a second reservation of a slot for a retransmission of the transport block. In some examples, the retransmission reservation manager 1160 may be configured as or otherwise support a means for transmitting, to the second UE via the slot, second reservation information for the retransmission of the transport block.

In some examples, the reservation information includes a respective TDRA and FDRA for the one or more transport blocks.

In some examples, to support transmitting the first SCI message indicating the reservation of the set of multiple slots, the slot aggregated packet reservation manager 1140 may be configured as or otherwise support a means for transmitting an indication of a beginning slot, and where respective second SCI messages transmitted via respective transport blocks of the one or more transport blocks indicate respective reservation information for the respective transport blocks.

In some examples, the slot selection manager 1165 may be configured as or otherwise support a means for selecting the set of multiple slots based on the set of multiple slots satisfying one or more conditions.

Additionally, or alternatively, the communications manager 1120 may support wireless communications at a second UE in accordance with examples as disclosed herein. In some examples, the slot aggregated packet reservation manager 1140 may be configured as or otherwise support a means for receiving, from a first UE, a first SCI message indicating a reservation of a set of multiple slots and indicating reservation information for a slot aggregated packet that is aggregated across one or more slots of the set of multiple slots, the slot aggregated packet including one or more transport blocks. In some examples, the slot aggregated packet manager 1135 may be configured as or otherwise support a means for receiving, from the first UE, the slot aggregated packet via the set of multiple slots based on the reservation information.

In some examples, to support receiving the first SCI message indicating the reservation of the set of multiple slots, the slot aggregated packet reservation manager 1140 may be configured as or otherwise support a means for receiving an indication of a beginning slot and a quantity of slots.

In some examples, the transport block feedback manager 1155 may be configured as or otherwise support a means for transmitting, to the first UE, feedback indicating unsuccessful reception of a transport block of the slot aggregated packet. In some examples, the retransmission reservation manager 1160 may be configured as or otherwise support a means for receiving, from the first UE and in response to the feedback, a second SCI message indicating a second reservation of a second set of multiple slots and second reservation information for a retransmission of the slot aggregated packet, the second reservation corresponding to the reservation and the second reservation information corresponding to the reservation information.

In some examples, the transport block feedback manager 1155 may be configured as or otherwise support a means for transmitting, to the first UE, feedback indicating unsuccessful reception of a transport block of the slot aggregated packet. In some examples, the retransmission reservation manager 1160 may be configured as or otherwise support a means for receiving, from the first UE and in response to the feedback, a second SCI message indicating a second reservation of a slot for a retransmission of the transport block. In some examples, the retransmission reservation manager 1160 may be configured as or otherwise support a means for receiving, from the first UE via the slot, second reservation information for the retransmission of the transport block.

In some examples, the reservation information includes a respective TDRA and FDRA for the one or more transport blocks.

In some examples, to support receiving the first SCI message indicating the reservation of the set of multiple slots, the slot aggregated packet reservation manager 1140 may be configured as or otherwise support a means for receiving an indication of a beginning slot, and where respective second SCI messages transmitted via respective transport blocks of the one or more transport blocks indicate respective reservation information for the respective transport blocks.

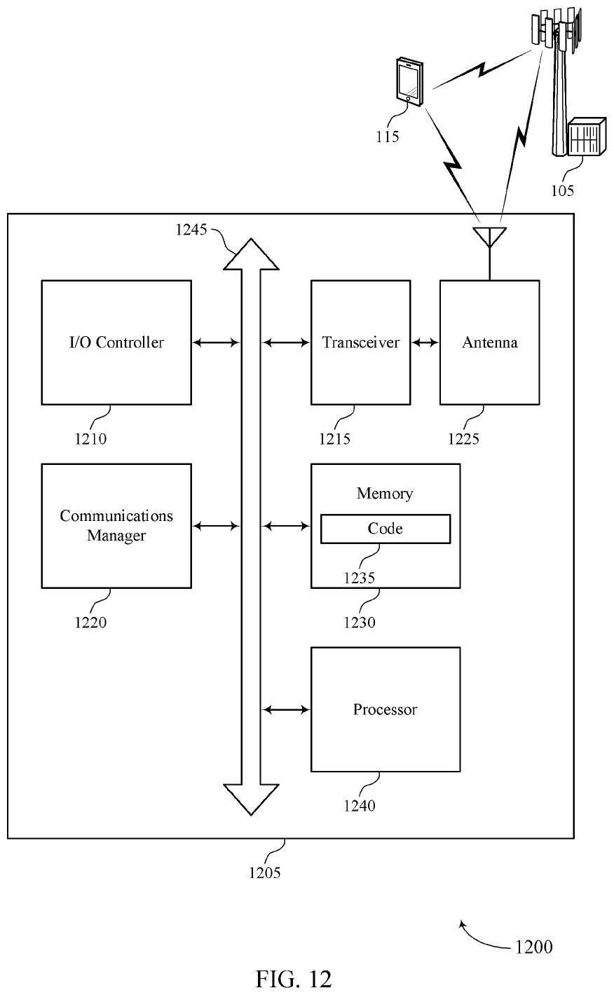

FIG. 12 shows a diagram of a system 1200 including a device 1205 that supports control signaling for transport blocks in slot aggregation in accordance with one or more aspects of the present disclosure. The device 1205 may be an example of or include the components of a device 905, a device 1005, or a UE 115 as described herein. The device 1205 may communicate (e.g., wirelessly) with one or more network entities 105, one or more UEs 115, or any combination thereof. The device 1205 may include components for bi-directional voice and data communications including components for transmitting and receiving communications, such as a communications manager 1220, an input/output (I/O) controller 1210, a transceiver 1215, an antenna 1225, a memory 1230, code 1235, and a processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally, or alternatively, the I/O controller 1210 may represent or interact with a modem, a keyboard, a mouse, a touchscreen, or a similar device. In some cases, the I/O controller 1210 may be implemented as part of a processor, such as the processor 1240. In some cases, a user may interact with the device 1205 via the I/O controller 1210 or via hardware components controlled by the I/O controller 1210.

In some cases, the device 1205 may include a single antenna 1225. However, in some other cases, the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include random access memory (RAM) and read-only memory (ROM). The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a basic I/O system (BIOS) which may control basic hardware or software operation such as the interaction with peripheral components or devices.

The processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting control signaling for transport blocks in slot aggregation). For example, the device 1205 or a component of the device 1205 may include a processor 1240 and memory 1230 coupled with or to the processor 1240, the processor 1240 and memory 1230 configured to perform various functions described herein.

The communications manager 1220 may support wireless communications at a first UE in accordance with examples as disclosed herein. For example, the communications manager 1220 may be configured as or otherwise support a means for transmitting, to a second UE, a first-stage SCI message associated with a set of multiple transport blocks, the first-stage SCI message indicating a common set of scheduling parameters common to the set of multiple transport blocks. The communications manager 1220 may be configured as or otherwise support a means for transmitting, to the second UE, at least one second-stage SCI message that indicates additional scheduling parameters for the set of multiple transport blocks. The communications manager 1220 may be configured as or otherwise support a means for transmitting, to the second UE, the set of multiple transport blocks via a set of multiple aggregated slots in accordance with the common set of scheduling parameters and the additional scheduling parameters.

Additionally, or alternatively, the communications manager 1220 may support wireless communications at a second UE in accordance with examples as disclosed herein. For example, the communications manager 1220 may be configured as or otherwise support a means for receiving, from a first UE, a first-stage SCI message associated with a set of multiple transport blocks, the first-stage SCI message indicating a common set of scheduling parameters common to the set of multiple transport blocks. The communications manager 1220 may be configured as or otherwise support a means for receiving, from the first UE, at least one second-stage SCI message that indicates additional scheduling parameters the set of multiple transport blocks. The communications manager 1220 may be configured as or otherwise support a means for receiving, from the first UE, the set of multiple transport blocks via a set of multiple aggregated slots in accordance with the common set of scheduling parameters and the additional scheduling parameters.

Additionally, or alternatively, the communications manager 1220 may support wireless communications at a first UE in accordance with examples as disclosed herein. For example, the communications manager 1220 may be configured as or otherwise support a means for transmitting, to a second UE, a first SCI message indicating a reservation of a set of multiple slots and indicating reservation information for a slot aggregated packet that is aggregated across one or more slots of the set of multiple slots, the slot aggregated packet including one or more transport blocks. The communications manager 1220 may be configured as or otherwise support a means for transmitting, to the second UE, the slot aggregated packet via the set of multiple slots based on the reservation information.

Additionally, or alternatively, the communications manager 1220 may support wireless communications at a second UE in accordance with examples as disclosed herein. For example, the communications manager 1220 may be configured as or otherwise support a means for receiving, from a first UE, a first SCI message indicating a reservation of a set of multiple slots and indicating reservation information for a slot aggregated packet that is aggregated across one or more slots of the set of multiple slots, the slot aggregated packet including one or more transport blocks. The communications manager 1220 may be configured as or otherwise support a means for receiving, from the first UE, the slot aggregated packet via the set of multiple slots based on the reservation information.

By including or configuring the communications manager 1220 in accordance with examples as described herein, the device 1205 may support techniques for more efficient utilization of communication resources and improved coordination between devices.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of control signaling for transport blocks in slot aggregation as described herein, or the processor 1240 and the memory 1230 may be otherwise configured to perform or support such operations.

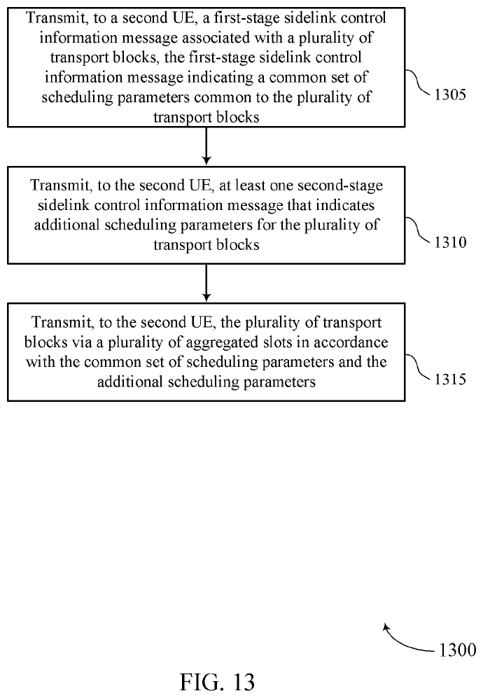

FIG. 13 shows a flowchart illustrating a method 1300 that supports control signaling for transport blocks in slot aggregation in accordance with one or more aspects of the present disclosure. The operations of the method 1300 may be implemented by a UE or its components as described herein. For example, the operations of the method 1300 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1305, the method may include transmitting, to a second UE, a first-stage SCI message associated with a set of multiple transport blocks, the first-stage SCI message indicating a common set of scheduling parameters common to the set of multiple transport blocks. The operations of 1305 may be performed in accordance with examples as disclosed herein. In some examples, aspects of the operations of 1305 may be performed by a common scheduling parameter manager 1125 as described with reference to FIG. 11.

At 1310, the method may include transmitting, to the second UE, at least one second-stage SCI message that indicates additional scheduling parameters for the set of multiple transport blocks. The operations of 1310 may be performed in accordance with examples as disclosed herein. In some examples, aspects of the operations of 1310 may be performed by an additional scheduling parameter manager 1130 as described with reference to FIG. 11.

At 1315, the method may include transmitting, to the second UE, the set of multiple transport blocks via a set of multiple aggregated slots in accordance with the common set of scheduling parameters and the additional scheduling parameters. The operations of 1315 may be performed in accordance with examples as disclosed herein. In some examples, aspects of the operations of 1315 may be performed by a slot aggregated packet manager 1135 as described with reference to FIG. 11.

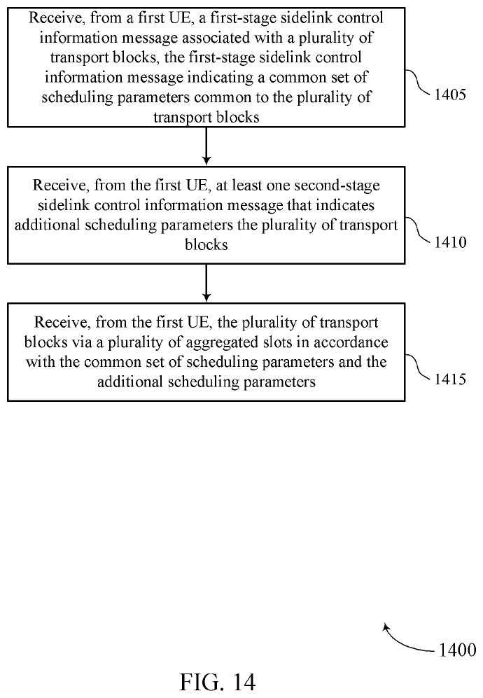

FIG. 14 shows a flowchart illustrating a method 1400 that supports control signaling for transport blocks in slot aggregation in accordance with one or more aspects of the present disclosure. The operations of the method 1400 may be implemented by a UE or its components as described herein. For example, the operations of the method 1400 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1405, the method may include receiving, from a first UE, a first-stage SCI message associated with a set of multiple transport blocks, the first-stage SCI message indicating a common set of scheduling parameters common to the set of multiple transport blocks. The operations of 1405 may be performed in accordance with examples as disclosed herein. In some examples, aspects of the operations of 1405 may be performed by a common scheduling parameter manager 1125 as described with reference to FIG. 11.

At 1410, the method may include receiving, from the first UE, at least one second-stage SCI message that indicates additional scheduling parameters the set of multiple transport blocks. The operations of 1410 may be performed in accordance with examples as disclosed herein. In some examples, aspects of the operations of 1410 may be performed by an additional scheduling parameter manager 1130 as described with reference to FIG. 11.

At 1415, the method may include receiving, from the first UE, the set of multiple transport blocks via a set of multiple aggregated slots in accordance with the common set of scheduling parameters and the additional scheduling parameters. The operations of 1415 may be performed in accordance with examples as disclosed herein. In some examples, aspects of the operations of 1415 may be performed by a slot aggregated packet manager 1135 as described with reference to FIG. 11.

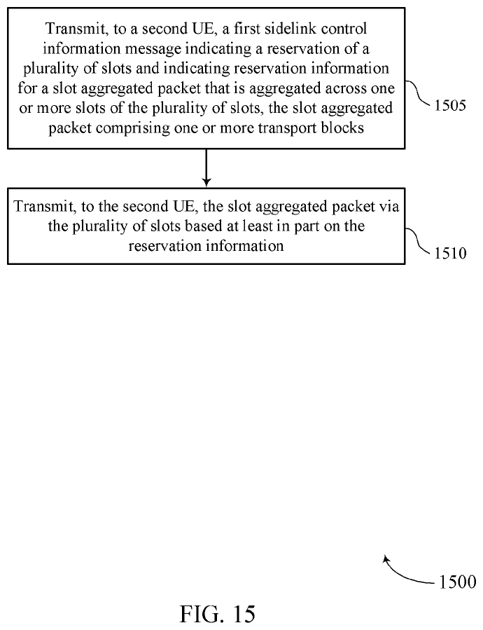

FIG. 15 shows a flowchart illustrating a method 1500 that supports control signaling for transport blocks in slot aggregation in accordance with one or more aspects of the present disclosure. The operations of the method 1500 may be implemented by a UE or its components as described herein. For example, the operations of the method 1500 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1505, the method may include transmitting, to a second UE, a first SCI message indicating a reservation of a set of multiple slots and indicating reservation information for a slot aggregated packet that is aggregated across one or more slots of the set of multiple slots, the slot aggregated packet including one or more transport blocks. The operations of 1505 may be performed in accordance with examples as disclosed herein. In some examples, aspects of the operations of 1505 may be performed by a slot aggregated packet reservation manager 1140 as described with reference to FIG. 11.

At 1510, the method may include transmitting, to the second UE, the slot aggregated packet via the set of multiple slots based on the reservation information. The operations of 1510 may be performed in accordance with examples as disclosed herein. In some examples, aspects of the operations of 1510 may be performed by a slot aggregated packet manager 1135 as described with reference to FIG. 11.

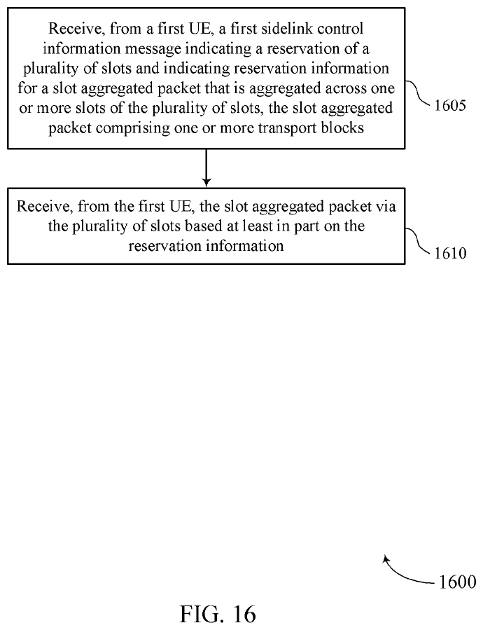

FIG. 16 shows a flowchart illustrating a method 1600 that supports control signaling for transport blocks in slot aggregation in accordance with one or more aspects of the present disclosure. The operations of the method 1600 may be implemented by a UE or its components as described herein. For example, the operations of the method 1600 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1605, the method may include receiving, from a first UE, a first SCI message indicating a reservation of a set of multiple slots and indicating reservation information for a slot aggregated packet that is aggregated across one or more slots of the set of multiple slots, the slot aggregated packet including one or more transport blocks. The operations of 1605 may be performed in accordance with examples as disclosed herein. In some examples, aspects of the operations of 1605 may be performed by a slot aggregated packet reservation manager 1140 as described with reference to FIG. 11.

At 1610, the method may include receiving, from the first UE, the slot aggregated packet via the set of multiple slots based on the reservation information. The operations of 1610 may be performed in accordance with examples as disclosed herein. In some examples, aspects of the operations of 1610 may be performed by a slot aggregated packet manager 1135 as described with reference to FIG. 11.

The following provides an overview of aspects of the present disclosure:
Aspect 1: A method for wireless communications at a first UE, comprising: transmitting, to a second UE, a first-stage SCI message associated with a plurality of transport blocks, the first-stage SCI message indicating a common set of scheduling parameters common to the plurality of transport blocks; transmitting, to the second UE, at least one second-stage SCI message that indicates additional scheduling parameters for the plurality of transport blocks; and transmitting, to the second UE, the plurality of transport blocks via a plurality of aggregated slots in accordance with the common set of scheduling parameters and the additional scheduling parameters.
Aspect 2: The method of aspect 1, wherein transmitting the at least one second-stage SCI message comprises: transmitting, via a temporally first slot of the plurality of aggregated slots, a plurality of second-stage SCI messages for the plurality of transport blocks.
Aspect 3: The method of aspect 2, wherein transmitting the first-stage SCI message comprises: transmitting an indication of a common format for the plurality of second-stage SCI messages.
Aspect 4: The method of aspect 1, wherein transmitting the at least one second-stage SCI message comprises: transmitting a single second-stage SCI message via a temporally first slot of the plurality of aggregated slots, the single second-stage SCI message including a plurality of sets of additional scheduling parameters for the plurality of transport blocks.
Aspect 5: The method of aspect 1, wherein transmitting the at least one second-stage SCI message comprises: transmitting, via a first transport block of the plurality of transport blocks, a first second-stage SCI message for the first transport block; and transmitting, via a second transport block of the plurality of transport blocks, a second second-stage SCI message for the second transport block.
Aspect 6: The method of aspect 5, wherein transmitting the first-stage SCI message comprises: transmitting an indication of a common format for the first second-stage SCI message and the second second-stage SCI message.
Aspect 7: The method of aspect 5, wherein transmitting the first-stage SCI message comprises: transmitting an indication of a first format for the first second-stage SCI message, wherein the first second-stage SCI message comprises an indication of a second format for the second second-stage SCI message.
Aspect 8: The method of aspect 5, wherein transmitting the first-stage SCI message comprises: transmitting an indication of a first format for the first second-stage SCI message, wherein the first second-stage SCI message comprises an indication of a second format for the second second-stage SCI message, and wherein the second second-stage SCI message comprises an indication of a third format for a third second-stage SCI message for a third transport block of the plurality of transport blocks.
Aspect 9: The method of aspect 1, wherein transmitting the at least one second-stage SCI message comprises: transmitting, via a temporally first slot of the plurality of aggregated slots, a first second-stage SCI message for a temporally first transport block of the plurality of transport blocks, the first second-stage SCI message comprising at least one scheduling parameter common to the plurality of transport blocks; and transmitting, via a second transport block of the plurality of transport blocks, a second second-stage SCI message comprising at least one scheduling parameter for the second transport block.
Aspect 10: The method of any of aspects 1 through 9, wherein transmitting the first-stage SCI message comprises: transmitting the first-stage SCI message via a temporally first slot of the plurality of aggregated slots.
Aspect 11: The method of any of aspects 1 through 10, wherein the additional scheduling parameters comprise one or more destination identifiers for the plurality of transport blocks, one or more modulation and coding schemes for the plurality of transport blocks, one or more TDRAs for the plurality of transport blocks, or a combination thereof.
Aspect 12: A method for wireless communications at a second UE, comprising: receiving, from a first UE, a first-stage SCI message associated with a plurality of transport blocks, the first-stage SCI message indicating a common set of scheduling parameters common to the plurality of transport blocks; receiving, from the first UE, at least one second-stage SCI message that indicates additional scheduling parameters the plurality of transport blocks; and receiving, from the first UE, the plurality of transport blocks via a plurality of aggregated slots in accordance with the common set of scheduling parameters and the additional scheduling parameters.
Aspect 13: The method of aspect 12, wherein receiving the at least one second-stage SCI message comprises: receiving, via a temporally first slot of the plurality of aggregated slots, a plurality of second-stage SCI messages for the plurality of transport blocks.
Aspect 14: The method of aspect 13, wherein receiving the first-stage SCI message comprises: receiving an indication of a common format for the plurality of second-stage SCI messages.
Aspect 15: The method of aspect 12, wherein receiving the at least one second-stage SCI message comprises: receiving a single second-stage SCI message via a temporally first slot of the plurality of aggregated slots, the single second-stage SCI message including a plurality of sets of additional scheduling parameters for the plurality of transport blocks.
Aspect 16: The method of aspect 12, wherein receiving the at least one second-stage SCI message comprises: receiving, via a first transport block of the plurality of transport blocks, a first second-stage SCI message for the first transport block; and receiving, via a second transport block of the plurality of transport blocks, a second second-stage SCI message for the second transport block.
Aspect 17: The method of aspect 16, wherein receiving the first-stage SCI message comprises: receiving an indication of a common format for the first second-stage SCI message and the second second-stage SCI message.
Aspect 18: The method of aspect 16, wherein receiving the first-stage SCI message comprises: receiving an indication of a first format for the first second-stage SCI message, wherein the first second-stage SCI message comprises an indication of a second format for the second second-stage SCI message.
Aspect 19: The method of aspect 16, wherein receiving the first-stage SCI message comprises: receiving an indication of a first format for the first second-stage SCI message, wherein the first second-stage SCI message comprises an indication of a second format for the second second-stage SCI message, and wherein the second second-stage SCI message comprises an indication of a third format for a third second-stage SCI message for a third transport block of the plurality of transport blocks.
Aspect 20: The method of aspect 12, wherein receiving the at least one second-stage SCI message comprises: receiving, via a temporally first slot of the plurality of aggregated slots, a first second-stage SCI message for a temporally first transport block of the plurality of transport blocks, the first second-stage SCI message comprising at least one scheduling parameter common to the plurality of transport blocks; and receiving, via a second transport block of the plurality of transport blocks, a second second-stage SCI message comprising at least one scheduling parameter for the second transport block.
Aspect 21: The method of any of aspects 12 through 20, wherein receiving the first-stage SCI message comprises: receiving the first-stage SCI message via a temporally first slot of the plurality of aggregated slots.
Aspect 22: The method of any of aspects 12 through 21, wherein the additional scheduling parameters comprise one or more destination identifiers for the plurality of transport blocks, one or more modulation and coding schemes for the plurality of transport blocks, one or more TDRAs for the plurality of transport blocks, or a combination thereof.
Aspect 23: A method for wireless communications at a first UE, comprising: transmitting, to a second UE, a first SCI message indicating a reservation of a plurality of slots and indicating reservation information for a slot aggregated packet that is aggregated across one or more slots of the plurality of slots, the slot aggregated packet comprising one or more transport blocks; and transmitting, to the second UE, the slot aggregated packet via the plurality of slots based at least in part on the reservation information.
Aspect 24: The method of aspect 23, wherein transmitting the first SCI message indicating the reservation of the plurality of slots comprises: transmitting an indication of a beginning slot and a quantity of slots.
Aspect 25: The method of any of aspects 23 through 24, further comprising: receiving, from the second UE, feedback indicating unsuccessful reception of a transport block of the slot aggregated packet; and transmitting, to the second UE and in response to the feedback, a second SCI message indicating a second reservation of a second plurality of slots and second reservation information for a retransmission of the slot aggregated packet, the second reservation corresponding to the reservation and the second reservation information corresponding to the reservation information.
Aspect 26: The method of any of aspects 23 through 24, further comprising: receiving, from the second UE, feedback indicating unsuccessful reception of a transport block of the slot aggregated packet; transmitting, to the second UE and in response to the feedback, a second SCI message indicating a second reservation of a slot for a retransmission of the transport block; and transmitting, to the second UE via the slot, second reservation information for the retransmission of the transport block.
Aspect 27: The method of any of aspects 23 through 26, wherein the reservation information comprises a respective TDRA and FDRA for the one or more transport blocks.
Aspect 28: The method of any of aspects 23 through 27, wherein transmitting the first SCI message indicating the reservation of the plurality of slots comprises: transmitting an indication of a beginning slot, and wherein respective second SCI messages transmitted via respective transport blocks of the one or more transport blocks indicate respective reservation information for the respective transport blocks.
Aspect 29: The method of any of aspects 23 through 28, further comprising: selecting the plurality of slots based at least in part on the plurality of slots satisfying one or more conditions.
Aspect 30: A method for wireless communications at a second UE, comprising: receiving, from a first UE, a first SCI message indicating a reservation of a plurality of slots and indicating reservation information for a slot aggregated packet that is aggregated across one or more slots of the plurality of slots, the slot aggregated packet comprising one or more transport blocks; and receiving, from the first UE, the slot aggregated packet via the plurality of slots based at least in part on the reservation information.
Aspect 31: The method of aspect 30, wherein receiving the first SCI message indicating the reservation of the plurality of slots comprises: receiving an indication of a beginning slot and a quantity of slots.
Aspect 32: The method of any of aspects 30 through 31, further comprising: transmitting, to the first UE, feedback indicating unsuccessful reception of a transport block of the slot aggregated packet; and receiving, from the first UE and in response to the feedback, a second SCI message indicating a second reservation of a second plurality of slots and second reservation information for a retransmission of the slot aggregated packet, the second reservation corresponding to the reservation and the second reservation information corresponding to the reservation information.
Aspect 33: The method of any of aspects 30 through 31, further comprising: transmitting, to the first UE, feedback indicating unsuccessful reception of a transport block of the slot aggregated packet; receiving, from the first UE and in response to the feedback, a second SCI message indicating a second reservation of a slot for a retransmission of the transport block; and receiving, from the first UE via the slot, second reservation information for the retransmission of the transport block.
Aspect 34: The method of any of aspects 30 through 33, wherein the reservation information comprises a respective TDRA and FDRA for the one or more transport blocks.
Aspect 35: The method of any of aspects 30 through 34, wherein receiving the first SCI message indicating the reservation of the plurality of slots comprises: receiving an indication of a beginning slot, and wherein respective second SCI messages transmitted via respective transport blocks of the one or more transport blocks indicate respective reservation information for the respective transport blocks.
Aspect 36: An apparatus for wireless communication at a first UE, comprising: a processor; and memory coupled with the processor, the processor configured to perform a method of any of aspects 1 through 11.
Aspect 37: An apparatus for wireless communications at a first UE, comprising at least one means for performing a method of any of aspects 1 through 11.
Aspect 38: A non-transitory computer-readable medium storing code for wireless communications at a first UE, the code comprising instructions executable by a processor to perform a method of any of aspects 1 through 11.
Aspect 39: An apparatus for wireless communication at a second UE, comprising: a processor; and memory coupled with the processor, the processor configured to perform a method of any of aspects 12 through 22.
Aspect 40: An apparatus for wireless communications at a second UE, comprising at least one means for performing a method of any of aspects 12 through 22.
Aspect 41: A non-transitory computer-readable medium storing code for wireless communications at a second UE, the code comprising instructions executable by a processor to perform a method of any of aspects 12 through 22.
Aspect 42: An apparatus for wireless communication at a first UE, comprising: a processor; and memory coupled with the processor, the processor configured to perform a method of any of aspects 23 through 29.
Aspect 43: An apparatus for wireless communications at a first UE, comprising at least one means for performing a method of any of aspects 23 through 29.
Aspect 44: A non-transitory computer-readable medium storing code for wireless communications at a first UE, the code comprising instructions executable by a processor to perform a method of any of aspects 23 through 29.
Aspect 45: An apparatus for wireless communication at a second UE, comprising: a processor; and memory coupled with the processor, the processor configured to perform a method of any of aspects 30 through 35.
Aspect 46: An apparatus for wireless communications at a second UE, comprising at least one means for performing a method of any of aspects 30 through 35.
Aspect 47: A non-transitory computer-readable medium storing code for wireless communications at a second UE, the code comprising instructions executable by a processor to perform a method of any of aspects 30 through 35.
Aspect 48: A method for wireless communications at a first UE, comprising: transmitting, to a second UE, a first SCI message associated with a plurality of transport blocks, the first SCI message indicating a common set of scheduling parameters common to the plurality of transport blocks; transmitting, to the second UE, at least one second SCI message that indicates additional scheduling parameters for the plurality of transport blocks; and transmitting, to the second UE, the plurality of transport blocks via a plurality of aggregated slots in accordance with the common set of scheduling parameters and the additional scheduling parameters.
Aspect 49: The method of aspect 48, wherein transmitting the at least one second SCI message comprises: transmitting, via a temporally first slot of the plurality of aggregated slots, a plurality of second SCI messages for the plurality of transport blocks.
Aspect 50: The method of aspect 49, wherein transmitting the first SCI message comprises: transmitting an indication of a common format for the plurality of second SCI messages.
Aspect 51: The method of aspect 48, wherein transmitting the at least one second SCI message comprises: transmitting a single second SCI message via a temporally first slot of the plurality of aggregated slots, the single second SCI message including a plurality of sets of additional scheduling parameters for the plurality of transport blocks.
Aspect 52: The method of aspect 48, wherein transmitting the at least one second SCI message comprises: transmitting, via a first transport block of the plurality of transport blocks, a first second SCI message for the first transport block; and transmitting, via a second transport block of the plurality of transport blocks, an additional second SCI message for the second transport block.
Aspect 53: The method of aspect 52, wherein transmitting the first SCI message comprises: transmitting an indication of a common format for the first second SCI message and the additional second SCI message.
Aspect 54: The method of aspect 52, wherein transmitting the first SCI message comprises: transmitting an indication of a first format for the first second SCI message, wherein the first second SCI message comprises an indication of a second format for the additional second SCI message.
Aspect 55: The method of aspect 52, wherein transmitting the first SCI message comprises: transmitting an indication of a first format for the first second SCI message, wherein the first second SCI message comprises an indication of a second format for the additional second SCI message, and wherein the additional second SCI message comprises an indication of a third format for a third second SCI message for a third transport block of the plurality of transport blocks.
Aspect 56: The method of aspect 48, wherein transmitting the at least one second SCI message comprises: transmitting, via a temporally first slot of the plurality of aggregated slots, a first second SCI message for a temporally first transport block of the plurality of transport blocks, the first second SCI message comprising at least one scheduling parameter common to the plurality of transport blocks; and transmitting, via a second transport block of the plurality of transport blocks, an additional second SCI message comprising at least one scheduling parameter for the second transport block.
Aspect 57: The method of any of aspects 48 through 56, wherein transmitting the first SCI message comprises: transmitting the first SCI message via a temporally first slot of the plurality of aggregated slots.
Aspect 58: The method of any of aspects 48 through 57, wherein the additional scheduling parameters comprise one or more destination identifiers for the plurality of transport blocks, one or more modulation and coding schemes for the plurality of transport blocks, one or more TDRAs for the plurality of transport blocks, or a combination thereof.
Aspect 59: A method for wireless communications at a second UE, comprising: receiving, from a first UE, a first SCI message associated with a plurality of transport blocks, the first SCI message indicating a common set of scheduling parameters common to the plurality of transport blocks; receiving, from the first UE, at least one second SCI message that indicates additional scheduling parameters the plurality of transport blocks; and receiving, from the first UE, the plurality of transport blocks via a plurality of aggregated slots in accordance with the common set of scheduling parameters and the additional scheduling parameters.
Aspect 60: The method of aspect 59, wherein receiving the at least one second SCI message comprises: receiving, via a temporally first slot of the plurality of aggregated slots, a plurality of second SCI messages for the plurality of transport blocks.
Aspect 61: The method of aspect 60, wherein receiving the first SCI message comprises: receiving an indication of a common format for the plurality of second SCI messages.
Aspect 62: The method of aspect 59, wherein receiving the at least one second SCI message comprises: receiving a single second SCI message via a temporally first slot of the plurality of aggregated slots, the single second SCI message including a plurality of sets of additional scheduling parameters for the plurality of transport blocks.
Aspect 63: The method of aspect 59, wherein receiving the at least one second SCI message comprises: receiving, via a first transport block of the plurality of transport blocks, a first second SCI message for the first transport block; and receiving, via a second transport block of the plurality of transport blocks, an additional second SCI message for the second transport block.
Aspect 64: The method of aspect 63, wherein receiving the first SCI message comprises: receiving an indication of a common format for the first second SCI message and the additional second SCI message.
Aspect 65: The method of aspect 63, wherein receiving the first SCI message comprises: receiving an indication of a first format for the first second SCI message, wherein the first second SCI message comprises an indication of a second format for the additional second SCI message.
Aspect 66: The method of aspect 63, wherein receiving the first SCI message comprises: receiving an indication of a first format for the first second SCI message, wherein the first second SCI message comprises an indication of a second format for the additional second SCI message, and wherein the additional second SCI message comprises an indication of a third format for a third second SCI message for a third transport block of the plurality of transport blocks.
Aspect 67: The method of aspect 59, wherein receiving the at least one second SCI message comprises: receiving, via a temporally first slot of the plurality of aggregated slots, a first second SCI message for a temporally first transport block of the plurality of transport blocks, the first second SCI message comprising at least one scheduling parameter common to the plurality of transport blocks; and receiving, via a second transport block of the plurality of transport blocks, an additional second SCI message comprising at least one scheduling parameter for the second transport block.
Aspect 68: The method of any of aspects 59 through 67, wherein receiving the first SCI message comprises: receiving the first SCI message via a temporally first slot of the plurality of aggregated slots.
Aspect 69: The method of any of aspects 59 through 68, wherein the additional scheduling parameters comprise one or more destination identifiers for the plurality of transport blocks, one or more modulation and coding schemes for the plurality of transport blocks, one or more TDRAs for the plurality of transport blocks, or a combination thereof.
Aspect 70: A method for wireless communications at a first UE, comprising: transmitting, to a second UE, a first SCI message indicating a reservation of a plurality of slots and indicating reservation information for a slot aggregated packet that is aggregated across one or more slots of the plurality of slots, the slot aggregated packet comprising one or more transport blocks; and transmitting, to the second UE, the slot aggregated packet via the plurality of slots based at least in part on the reservation information.
Aspect 71: The method of aspect 70, wherein transmitting the first SCI message indicating the reservation of the plurality of slots comprises: transmitting an indication of a beginning slot and a quantity of slots.
Aspect 72: The method of any of aspects 70 through 71, further comprising: receiving, from the second UE, feedback indicating unsuccessful reception of a transport block of the slot aggregated packet; and transmitting, to the second UE and in response to the feedback, a second SCI message indicating a second reservation of a second plurality of slots and second reservation information for a retransmission of the slot aggregated packet, the second reservation corresponding to the reservation and the second reservation information corresponding to the reservation information.
Aspect 73: The method of any of aspects 70 through 71, further comprising: receiving, from the second UE, feedback indicating unsuccessful reception of a transport block of the slot aggregated packet; transmitting, to the second UE and in response to the feedback, a second SCI message indicating a second reservation of a slot for a retransmission of the transport block; and transmitting, to the second UE via the slot, second reservation information for the retransmission of the transport block.
Aspect 74: The method of any of aspects 70 through 73, wherein the reservation information comprises a respective TDRA and FDRA for the one or more transport blocks.
Aspect 75: The method of any of aspects 70 through 74, wherein transmitting the first SCI message indicating the reservation of the plurality of slots comprises: transmitting an indication of a beginning slot, and wherein respective second SCI messages transmitted via respective transport blocks of the one or more transport blocks indicate respective reservation information for the respective transport blocks.
Aspect 76: The method of any of aspects 70 through 75, further comprising: selecting the plurality of slots based at least in part on the plurality of slots satisfying one or more conditions.
Aspect 77: A method for wireless communications at a second UE, comprising: receiving, from a first UE, a first SCI message indicating a reservation of a plurality of slots and indicating reservation information for a slot aggregated packet that is aggregated across one or more slots of the plurality of slots, the slot aggregated packet comprising one or more transport blocks; and receiving, from the first UE, the slot aggregated packet via the plurality of slots based at least in part on the reservation information.
Aspect 78: The method of aspect 77, wherein receiving the first SCI message indicating the reservation of the plurality of slots comprises: receiving an indication of a beginning slot and a quantity of slots.
Aspect 79: The method of any of aspects 77 through 78, further comprising: transmitting, to the first UE, feedback indicating unsuccessful reception of a transport block of the slot aggregated packet; and receiving, from the first UE and in response to the feedback, a second SCI message indicating a second reservation of a second plurality of slots and second reservation information for a retransmission of the slot aggregated packet, the second reservation corresponding to the reservation and the second reservation information corresponding to the reservation information.
Aspect 80: The method of any of aspects 77 through 78, further comprising: transmitting, to the first UE, feedback indicating unsuccessful reception of a transport block of the slot aggregated packet; receiving, from the first UE and in response to the feedback, a second SCI message indicating a second reservation of a slot for a retransmission of the transport block; and receiving, from the first UE via the slot, second reservation information for the retransmission of the transport block.
Aspect 81: The method of any of aspects 77 through 80, wherein the reservation information comprises a respective TDRA and FDRA for the one or more transport blocks.
Aspect 82: The method of any of aspects 77 through 81, wherein receiving the first SCI message indicating the reservation of the plurality of slots comprises: receiving an indication of a beginning slot, and wherein respective second SCI messages transmitted via respective transport blocks of the one or more transport blocks indicate respective reservation information for the respective transport blocks.
Aspect 83: An apparatus for wireless communication at a first UE, comprising: a processor; and memory coupled with the processor, the processor configured to perform a method of any of aspects 48 through 58.
Aspect 84: An apparatus for wireless communications at a first UE, comprising at least one means for performing a method of any of aspects 48 through 58.
Aspect 85: A non-transitory computer-readable medium storing code for wireless communications at a first UE, the code comprising instructions executable by a processor to perform a method of any of aspects 48 through 58.
Aspect 86: An apparatus for wireless communication at a second UE, comprising: a processor; and memory coupled with the processor, the processor configured to perform a method of any of aspects 59 through 69.
Aspect 87: An apparatus for wireless communications at a second UE, comprising at least one means for performing a method of any of aspects 59 through 69.
Aspect 88: A non-transitory computer-readable medium storing code for wireless communications at a second UE, the code comprising instructions executable by a processor to perform a method of any of aspects 59 through 69.
Aspect 89: An apparatus for wireless communication at a first UE, comprising: a processor; and memory coupled with the processor, the processor configured to perform a method of any of aspects 70 through 76.
Aspect 90: An apparatus for wireless communications at a first UE, comprising at least one means for performing a method of any of aspects 70 through 76.
Aspect 91: A non-transitory computer-readable medium storing code for wireless communications at a first UE, the code comprising instructions executable by a processor to perform a method of any of aspects 70 through 76.
Aspect 92: An apparatus for wireless communication at a second UE, comprising: a processor; and memory coupled with the processor, the processor configured to perform a method of any of aspects 77 through 82.
Aspect 93: An apparatus for wireless communications at a second UE, comprising at least one means for performing a method of any of aspects 77 through 82.
Aspect 94: A non-transitory computer-readable medium storing code for wireless communications at a second UE, the code comprising instructions executable by a processor to perform a method of any of aspects 77 through 82.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a first user equipment (UE), comprising:
a processor; and
memory coupled with the processor, the processor configured to:
transmit, to a second UE, a first-stage sidelink control information message associated with a plurality of transport blocks, the first-stage sidelink control information message indicating a common set of scheduling parameters common to the plurality of transport blocks;
transmit, to the second UE, at least one second-stage sidelink control information message that indicates additional scheduling parameters for the plurality of transport blocks; and
transmit, to the second UE, the plurality of transport blocks via a plurality of aggregated slots in accordance with the common set of scheduling parameters and the additional scheduling parameters.

2. The apparatus of claim 1, wherein, to transmit the at least one second-stage sidelink control information message, the processor is configured to:
transmit, via a temporally first slot of the plurality of aggregated slots, a plurality of second-stage sidelink control information messages for the plurality of transport blocks.

3. The apparatus of claim 2, wherein, to transmit the first-stage sidelink control information message, the processor is configured to:
transmit an indication of a common format for the plurality of second-stage sidelink control information messages.

4. The apparatus of claim 1, wherein, to transmit the at least one second-stage sidelink control information message, the processor is configured to:
transmit a single second-stage sidelink control information message via a temporally first slot of the plurality of aggregated slots, the single second-stage sidelink control information message including a plurality of sets of additional scheduling parameters for the plurality of transport blocks.

5. The apparatus of claim 1, wherein, to transmit the at least one second-stage sidelink control information message, the processor is configured to:
transmit, via a first transport block of the plurality of transport blocks, a first second-stage sidelink control information message for the first transport block; and
transmit, via a second transport block of the plurality of transport blocks, a second second-stage sidelink control information message for the second transport block.

6. The apparatus of claim 5, wherein, to transmit the first-stage sidelink control information message, the processor is configured to:
transmit an indication of a common format for the first second-stage sidelink control information message and the second second-stage sidelink control information message.

7. The apparatus of claim 5, wherein, to transmit the first-stage sidelink control information message, the processor is configured to:
transmit an indication of a first format for the first second-stage sidelink control information message, wherein the first second-stage sidelink control information message comprises an indication of a second format for the second second-stage sidelink control information message.

8. The apparatus of claim 5, wherein, to transmit the first-stage sidelink control information message, the processor is configured to:
transmit an indication of a first format for the first second-stage sidelink control information message, wherein the first second-stage sidelink control information message comprises an indication of a second format for the second second-stage sidelink control information message, and wherein the second second-stage sidelink control information message comprises an indication of a third format for a third second-stage sidelink control information message for a third transport block of the plurality of transport blocks.

9. The apparatus of claim 1, wherein, to transmit the at least one second-stage sidelink control information message, the processor is configured to:
transmit, via a temporally first slot of the plurality of aggregated slots, a first second-stage sidelink control information message for a temporally first transport block of the plurality of transport blocks, the first second-stage sidelink control information message comprising at least one scheduling parameter common to the plurality of transport blocks; and
transmit, via a second transport block of the plurality of transport blocks, a second second-stage sidelink control information message comprising at least one scheduling parameter for the second transport block.

10. The apparatus of claim 1, further comprising:
an antenna, wherein, to transmit the first-stage sidelink control information message, the processor is configured to:
transmit, via the antenna, the first-stage sidelink control information message via a temporally first slot of the plurality of aggregated slots.

11. The apparatus of claim 1, wherein the additional scheduling parameters comprise one or more destination identifiers for the plurality of transport blocks, one or more modulation and coding schemes for the plurality of transport blocks, one or more time domain resource allocations for the plurality of transport blocks, or a combination thereof.

12. An apparatus for wireless communication at a second user equipment (UE), comprising:
a processor; and
memory coupled with the processor, the processor configured to:
receive, from a first UE, a first-stage sidelink control information message associated with a plurality of transport blocks, the first-stage sidelink control information message indicating a common set of scheduling parameters common to the plurality of transport blocks;
receive, from the first UE, at least one second-stage sidelink control information message that indicates additional scheduling parameters the plurality of transport blocks; and
receive, from the first UE, the plurality of transport blocks via a plurality of aggregated slots in accordance with the common set of scheduling parameters and the additional scheduling parameters.

13. The apparatus of claim 12, wherein, to receive the at least one second-stage sidelink control information message, the processor is configured to:
receive, via a temporally first slot of the plurality of aggregated slots, a plurality of second-stage sidelink control information messages for the plurality of transport blocks.

14. The apparatus of claim 13, wherein, to receive the first-stage sidelink control information message, the processor is configured to:
receive an indication of a common format for the plurality of second-stage sidelink control information messages.

15. The apparatus of claim 12, wherein, to receive the at least one second-stage sidelink control information message, the processor is configured to:
receive a single second-stage sidelink control information message via a temporally first slot of the plurality of aggregated slots, the single second-stage sidelink control information message including a plurality of sets of additional scheduling parameters for the plurality of transport blocks.

16. The apparatus of claim 12, wherein, to receive the at least one second-stage sidelink control information message, the processor is configured to:
receive, via a first transport block of the plurality of transport blocks, a first second-stage sidelink control information message for the first transport block; and
receive, via a second transport block of the plurality of transport blocks, a second second-stage sidelink control information message for the second transport block.

17. The apparatus of claim 16, wherein, to receive the first-stage sidelink control information message, the processor is configured to:
receive an indication of a common format for the first second-stage sidelink control information message and the second second-stage sidelink control information message.

18. The apparatus of claim 16, wherein, to receive the first-stage sidelink control information message, the processor is configured to:
receive an indication of a first format for the first second-stage sidelink control information message, wherein the first second-stage sidelink control information message comprises an indication of a second format for the second second-stage sidelink control information message.

19. The apparatus of claim 16, wherein, to receive the first-stage sidelink control information message, the processor is configured to:
receive an indication of a first format for the first second-stage sidelink control information message, wherein the first second-stage sidelink control information message comprises an indication of a second format for the second second-stage sidelink control information message, and wherein the second second-stage sidelink control information message comprises an indication of a third format for a third second-stage sidelink control information message for a third transport block of the plurality of transport blocks.

20. The apparatus of claim 12, wherein, to receive the at least one second-stage sidelink control information message, the processor is configured to:
receive, via a temporally first slot of the plurality of aggregated slots, a first second-stage sidelink control information message for a temporally first transport block of the plurality of transport blocks, the first second-stage sidelink control information message comprising at least one scheduling parameter common to the plurality of transport blocks; and
receive, via a second transport block of the plurality of transport blocks, a second second-stage sidelink control information message comprising at least one scheduling parameter for the second transport block.

21. The apparatus of claim 12, further comprising:
an antenna, wherein, to receive the first-stage sidelink control information message, the processor is configured to:
receive, via the antenna, the first-stage sidelink control information message via a temporally first slot of the plurality of aggregated slots.

22. The apparatus of claim 12, wherein the additional scheduling parameters comprise one or more destination identifiers for the plurality of transport blocks, one or more modulation and coding schemes for the plurality of transport blocks, one or more time domain resource allocations for the plurality of transport blocks, or a combination thereof.

23. An apparatus for wireless communication at a first user equipment (UE), comprising:
a processor; and
memory coupled with the processor, the processor configured to:
transmit, to a second UE, a first sidelink control information message indicating a reservation of a plurality of slots and indicating reservation information for a slot aggregated packet that is aggregated across one or more slots of the plurality of slots, the slot aggregated packet comprising one or more transport blocks; and
transmit, to the second UE, the slot aggregated packet via the plurality of slots based at least in part on the reservation information.

24. The apparatus of claim 23, further comprising:
an antenna, wherein, to transmit the first sidelink control information message indicating the reservation of the plurality of slots, the processor is configured to:
transmit, via the antenna, an indication of a beginning slot and a quantity of slots.

25. The apparatus of claim 23, wherein the processor is further configured to:
receive, from the second UE, feedback indicating unsuccessful reception of a transport block of the slot aggregated packet; and
transmit, to the second UE and in response to the feedback, a second sidelink control information message indicating a second reservation of a second plurality of slots and second reservation information for a retransmission of the slot aggregated packet, the second reservation corresponding to the reservation and the second reservation information corresponding to the reservation information.

26. The apparatus of claim 23, wherein the processor is further configured to:
receive, from the second UE, feedback indicating unsuccessful reception of a transport block of the slot aggregated packet;
transmit, to the second UE and in response to the feedback, a second sidelink control information message indicating a second reservation of a slot for a retransmission of the transport block; and
transmit, to the second UE via the slot, second reservation information for the retransmission of the transport block.

27. The apparatus of claim 23, wherein the reservation information comprises a respective time domain resource allocation and frequency domain resource allocation for the one or more transport blocks.

28. The apparatus of claim 23, wherein, to transmit the first sidelink control information message indicating the reservation of the plurality of slots, the processor is further configured to:
transmit an indication of a beginning slot, and wherein respective second sidelink control information messages transmitted via respective transport blocks of the one or more transport blocks indicate respective reservation information for the respective transport blocks.

29. The apparatus of claim 23, wherein the processor is further configured to:
select the plurality of slots based at least in part on the plurality of slots satisfying one or more conditions.

30. An apparatus for wireless communication at a second user equipment (UE), comprising:
a processor; and
memory coupled with the processor, the processor configured to:
receive, from a first UE, a first sidelink control information message indicating a reservation of a plurality of slots and indicating reservation information for a slot aggregated packet that is aggregated across one or more slots of the plurality of slots, the slot aggregated packet comprising one or more transport blocks; and
receive, from the first UE, the slot aggregated packet via the plurality of slots based at least in part on the reservation information.
